(19) United States
(12) Patent Application Publication
(10) Pub. No.: US 2014/0072329 A1
(43) Pub. Date: Mar. 13, 2014

(54) DEVELOPER ACCOMMODATING UNIT

(71) Applicant: CANON KABUSHIKI KAISHA, Tokyo (JP)

(72) Inventors: Tetsuo Uesugi, Kawasaki-shi (JP); Masaki Furutani, Tokyo (JP); Kojiro Yasui, Numazu-shi (JP); Hiroomi Matsuzaki, Mishima-shi (JP)

(73) Assignee: CANON KABUSHIKI KAISHA, Tokyo (JP)

(21) Appl. No.: 14/017,340

(22) Filed: Sep. 4, 2013

(30) Foreign Application Priority Data
Sep. 10, 2012 (JP) 2012-198090

(51) Int. Cl. G03G 15/08

(52) U.S. Cl. CPC G03G 15/0874
USPC 399/106; 399/262; 399/258

(57) ABSTRACT

A developer accommodating unit for accommodating a developer includes: a flexible container, provided with an opening for permitting discharge of the developer, for accommodating the developer; and a frame. The flexible container is provided with a fastening hole for fastening said flexible container in said frame. The frame includes a fixing shaft portion fixed in the fastening hole by being inserted into the fastening hole and includes a retaining portion for preventing the fixing shaft portion from being disengaged from the fastening hole. The fastening hole is locked by fitting the fastening hole around the fixing shaft portion while an edge of the fastening hole rides over the retaining portion by elastic deformation thereof.

### FIELD OF THE INVENTION AND RELATED ART

The present invention relates to a developer accommodating unit to be used in an image forming apparatus.

As the image forming apparatus featuring an image on a sheet by using an electrophotographic image forming process, there are, e.g., an electrophotographic copying machine and an electrophotographic printer (such as LED (light emitting diode) printer or laser beam printer). Further, an electrophotographic facsimile machine and the like are used.

To the image forming apparatus, a cartridge in which a developer is accommodated is provided so as to be detachable countable. Here, the cartridge refers to a cartridge which is constituted integrally with a developing device at least accommodating a developing means and the developer and which is made detachably mountable to an image forming apparatus main assembly or a cartridge which is constituted integrally with the developing device and a photosensitive member unit at least including a photosensitive member and which is made detachably mountable to the image forming apparatus main assembly.

Further, the developer accommodating unit is to be accommodated in the image forming apparatus or she cartridge. The developer accommodating unit includes at least a flexible container for accommodating the developer.

In a conventional electrophotographic image forming apparatus using the electrophotographic image forming process, a process cartridge type in which an electrophotographic photosensitive member and process means actable thereon are integrally assembled into a cartridge and the cartridge is made detachably mountable to an electrophotographic image forming apparatus main assembly has been employed.

In such a process cartridge, as described in Japanese Laid-open Patent Application (JP-A) Hei 4-66960, an opening provided in a developer accommodating frame for accommodating the developer (toner, carrier and the like) is sealed with a sealing member. Then, a bonding portion of a toner seal member as the sealing member is peeled off during use to permit supply of the developer. Such a type has been widely employed.

Further, in order to solve a problem, such that the developer is scattered in the process cartridge in a developer failing step during manufacturing of the process cartridge, a flexible container used as an inside container has been proposed.

However, as a fixing method of the flexible container to the frame as described in JP-A Hei 4-66980, ultrasonic caulking for crushing a boss of the frame is used.

### SUMMARY OF THE INVENTION

A principal object of the present invention is to provide a developer accommodating unit, a process cartridge and an image forming apparatus which are capable of fixing a flexible container to a frame by a simple method.

According to an aspect of the present invention, there is provided a developer accommodating unit for accommodating a developer, comprising: a flexible container, provided, with an opening for permitting discharge of the developer, for accommodating the developer; and a frame, wherein said flexible container is provided with a fastening hole for fastening said flexible container in said frame, wherein the frame includes a fixing shaft portion fixed in the fastening hole by being inserted into the fastening hole and includes a retaining portion for preventing the fixing shaft portion from being disengaged from the fastening hole, and wherein the fastening hole is locked by fitting the fastening hole around the fixing shaft portion while an edge of the fastening hole rides over the retaining portion by elastic deformation thereof.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a sectional illustration showing a structure of an image forming apparatus including a developer accommodating unit according to the present invention.

FIG. 2 is a sectional illustration showing a structure of a process cartridge including the developer accommodating unit.

FIG. 3 is a perspective illustration showing a state in which an opening of a flexible container is unsealed (opened) by an unsealing member in the developer accommodating unit.

Part (a) of FIG. 4 is a sectional illustration showing a state before she unsealing in the developer accommodating unit in First Embodiment of the present invention, and (b) of FIG. 4 is a partly enlarged view of (a) of FIG. 4.

FIG. 5 is a perspective illustration showing a state before unsealing of a developer accommodating container in First Embodiment.

FIG. 6 is an illustration of a retaining portion in First Embodiment as seen by projecting the retaining portion on a plane perpendicular to an axis of a fixing shaft portion.

Parts (a) to (c) of FIG. 7 are perspective views for illustrating a state in which an edge portion of a fastening hole rides over the retaining portion by its elastic deformation to look the fastening hole by the fixing shaft portion inserted into the fastening hole in First Embodiment.

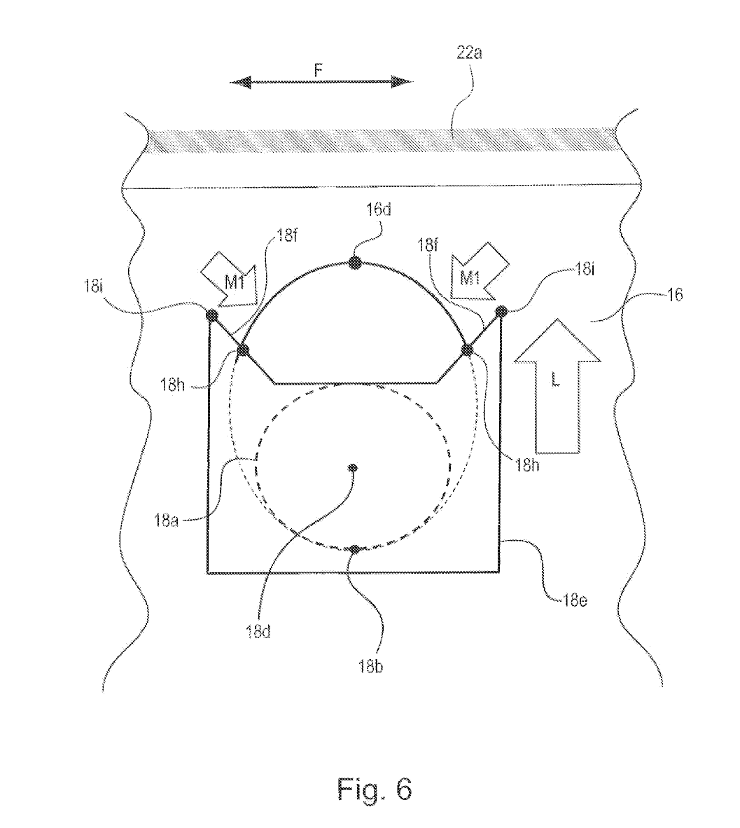

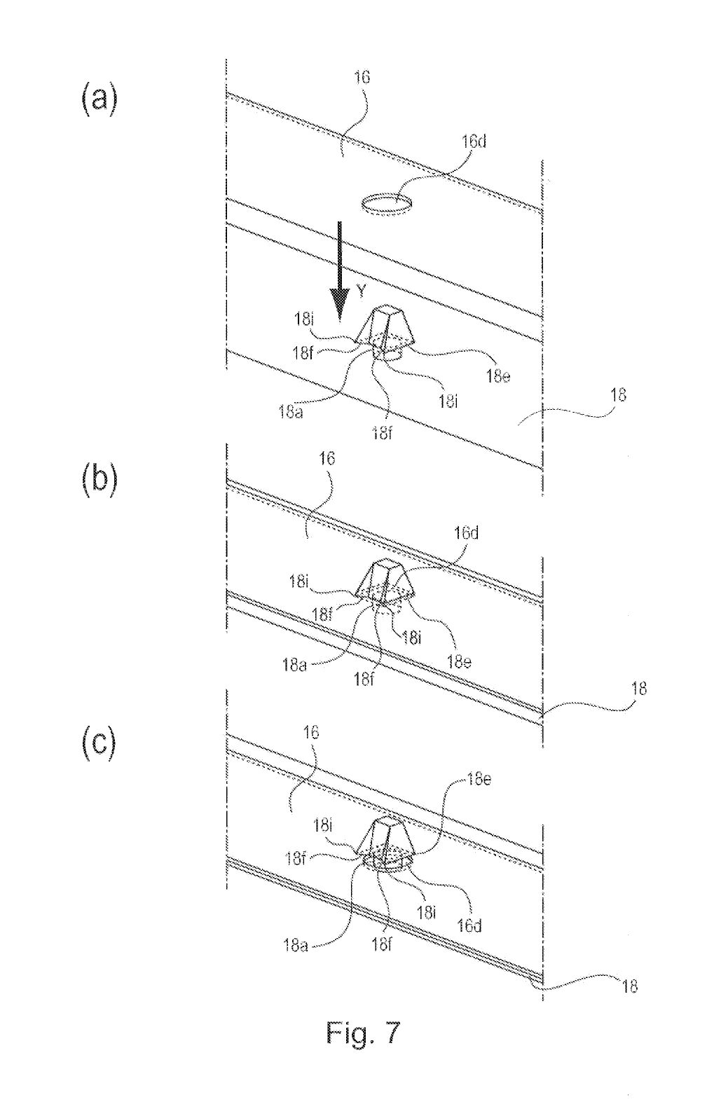

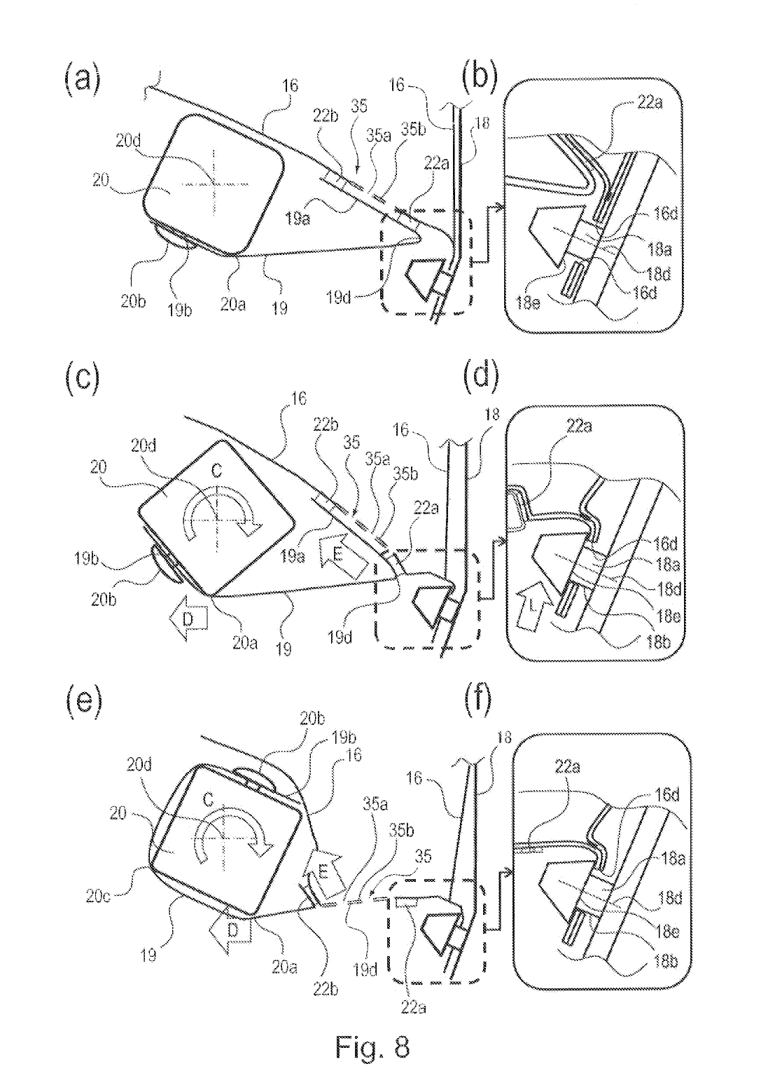

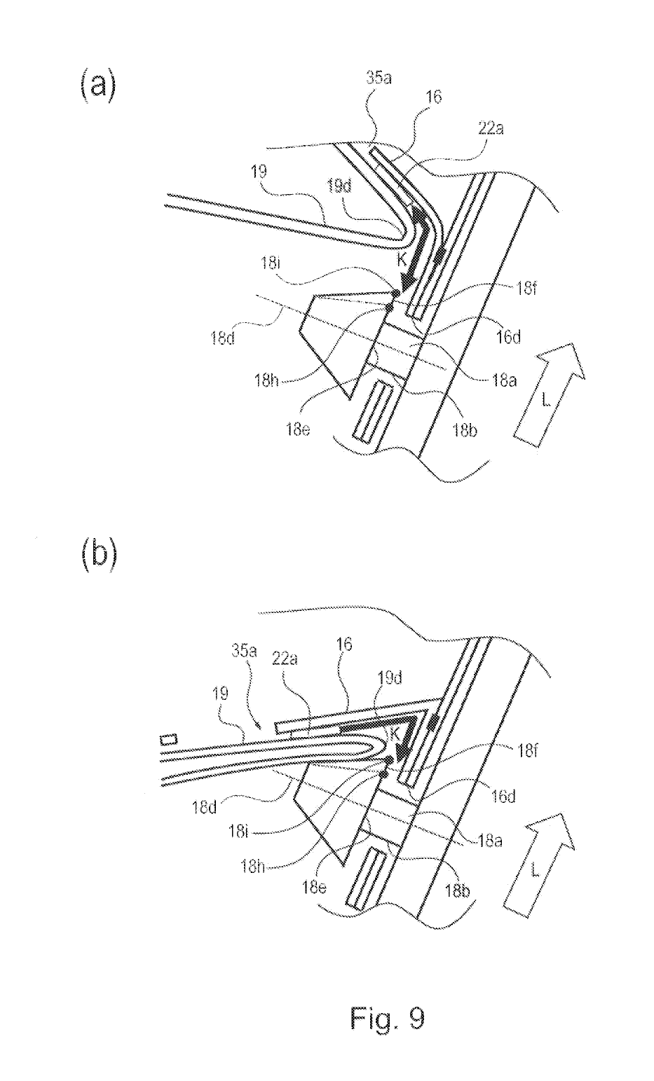

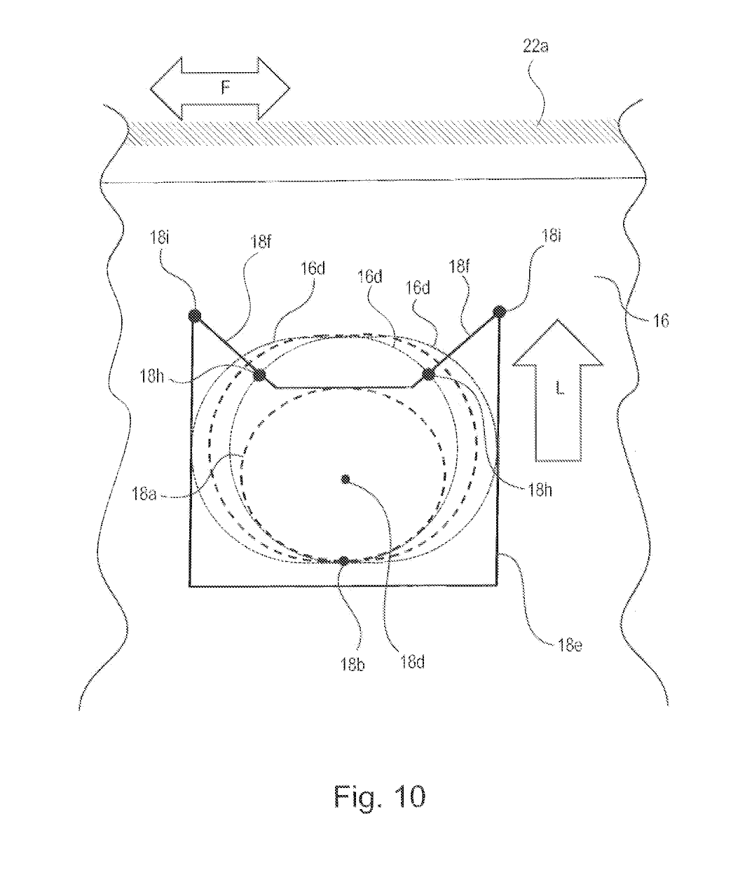

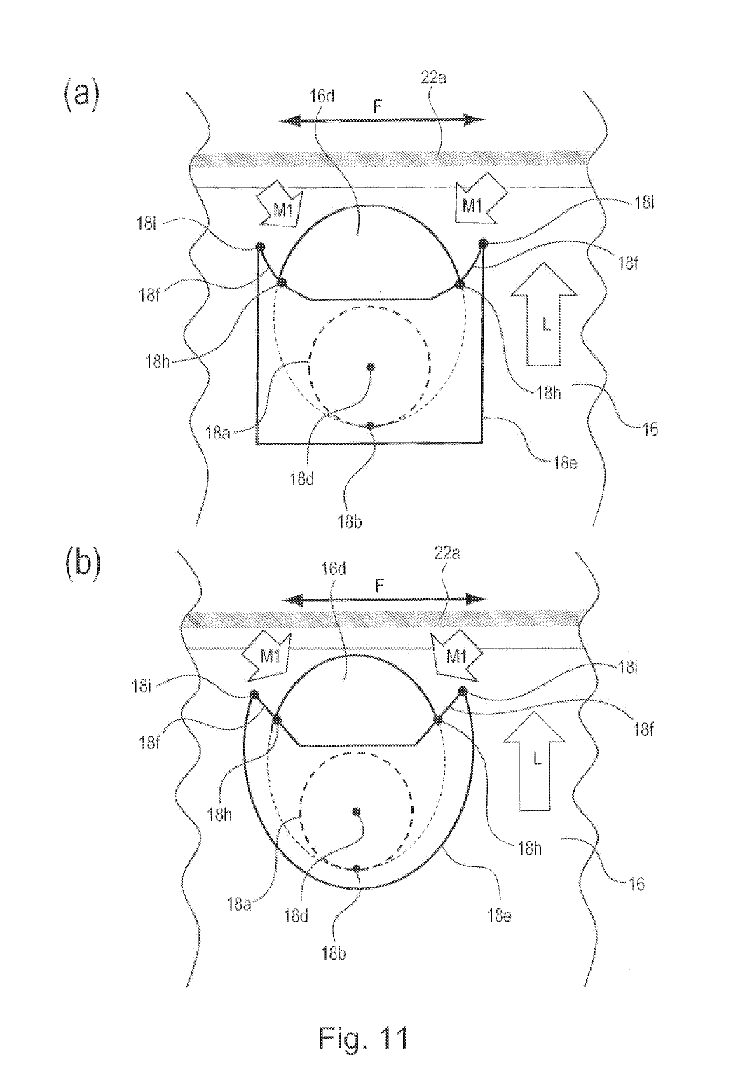

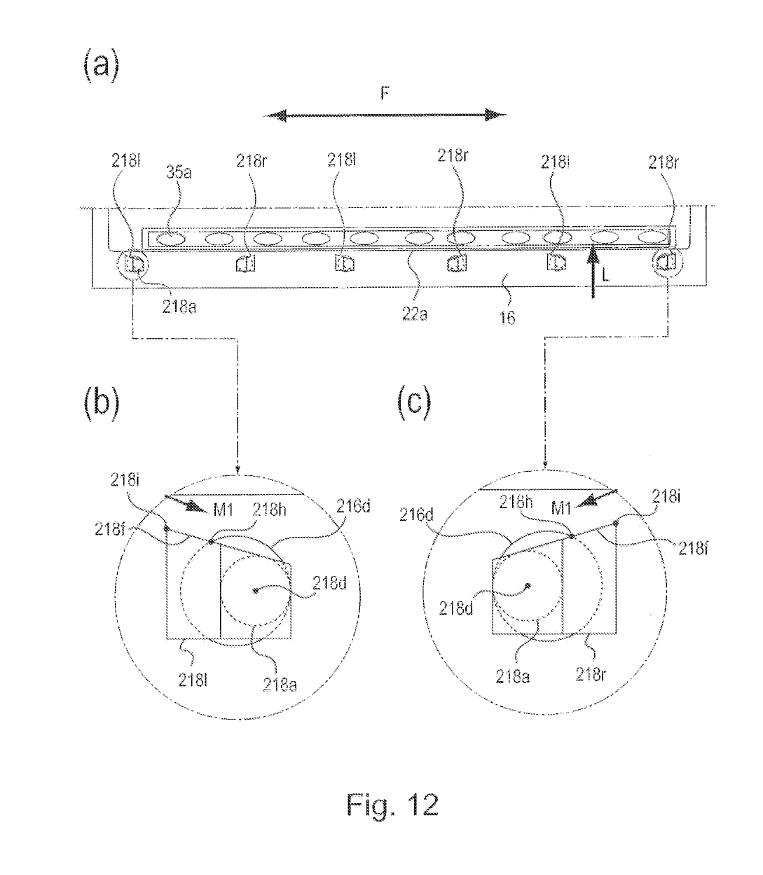

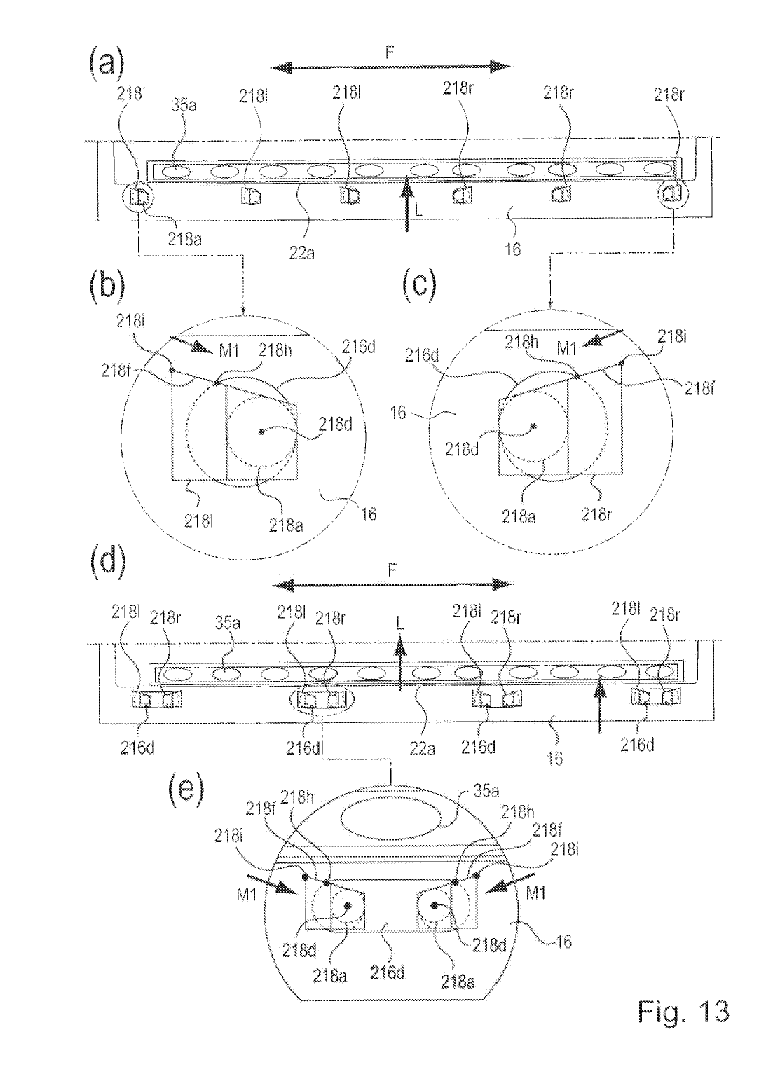

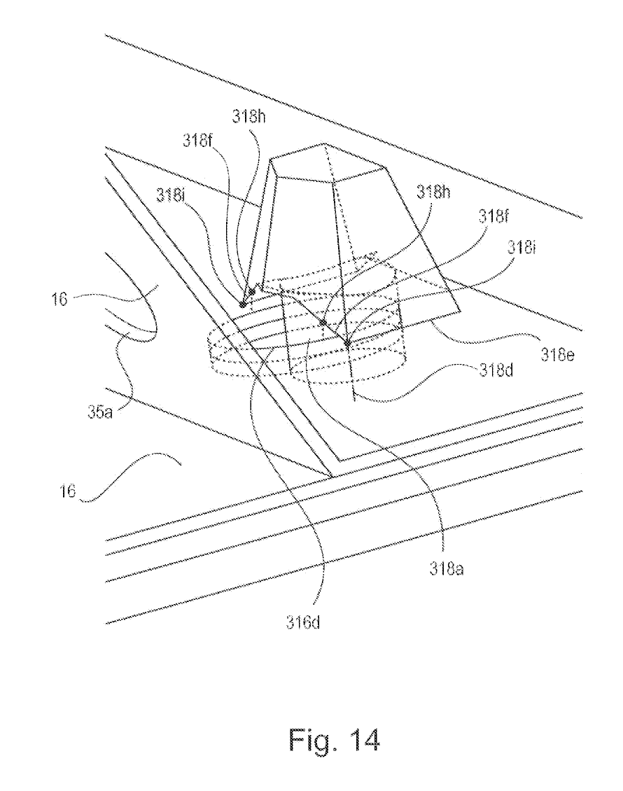

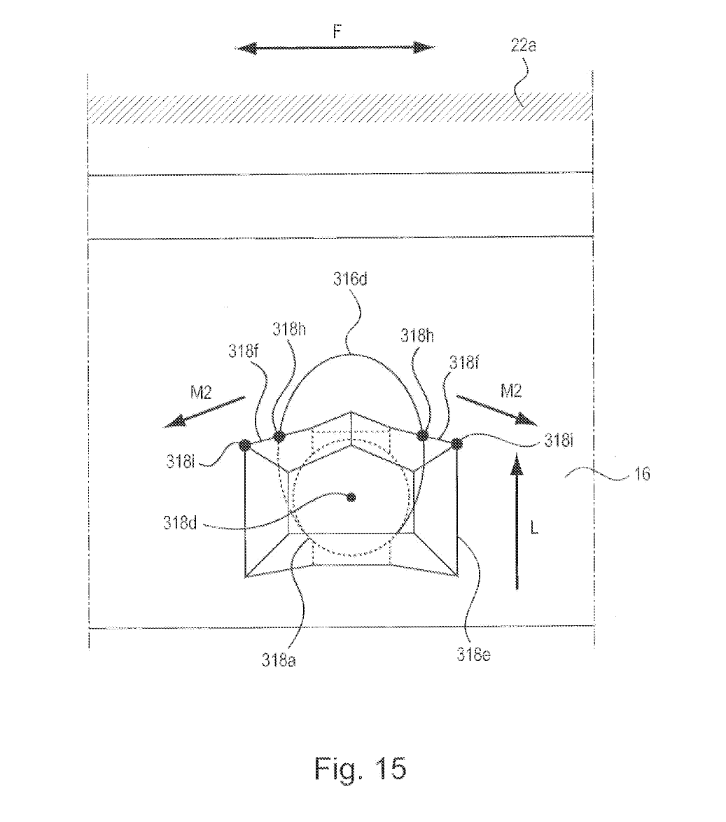

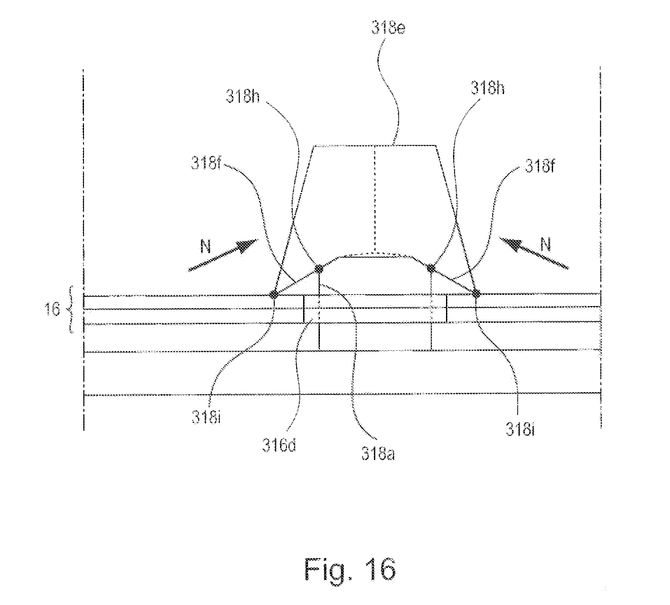

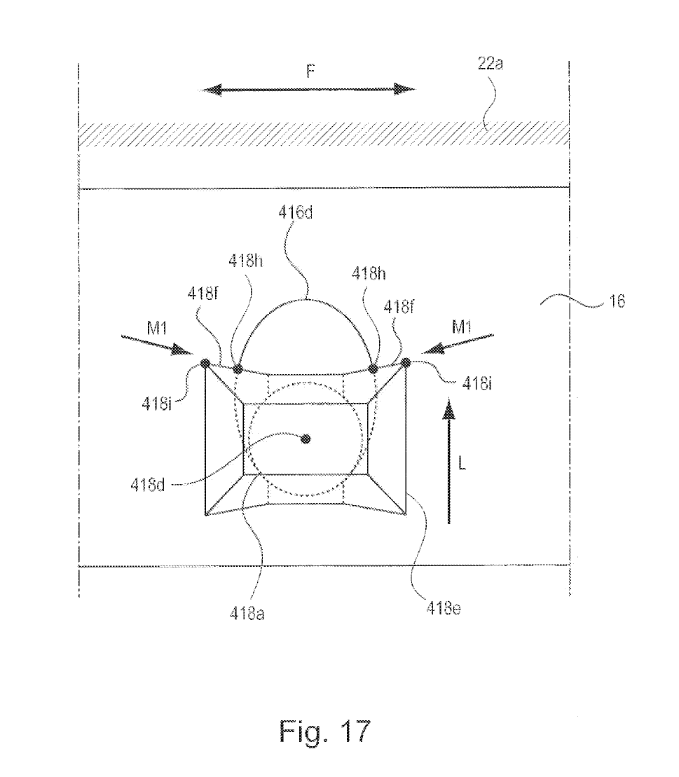

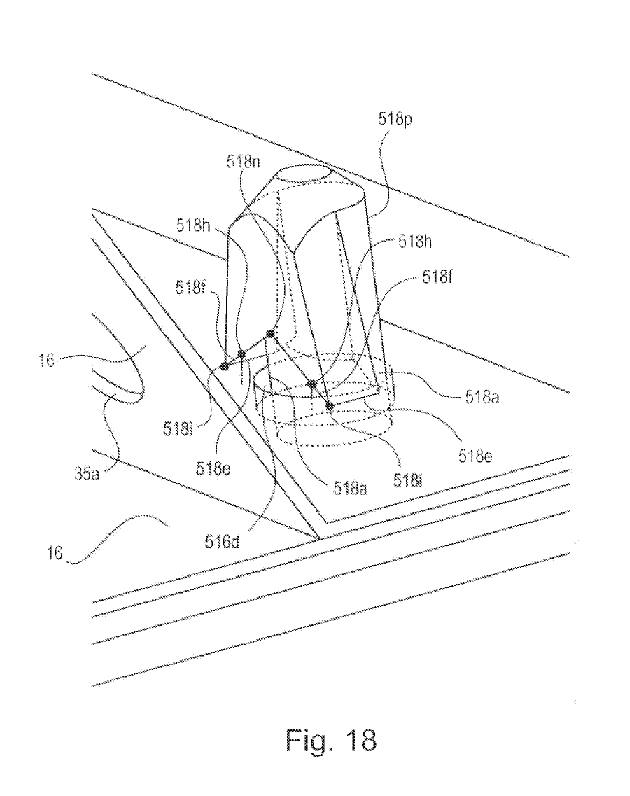

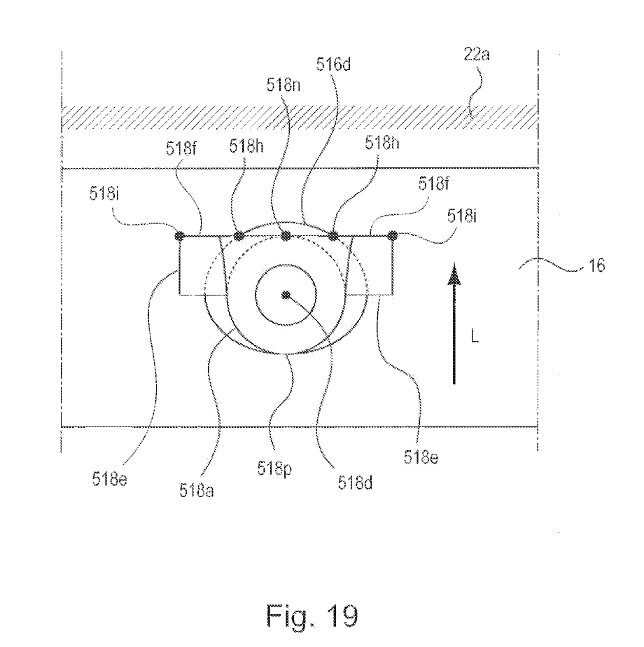

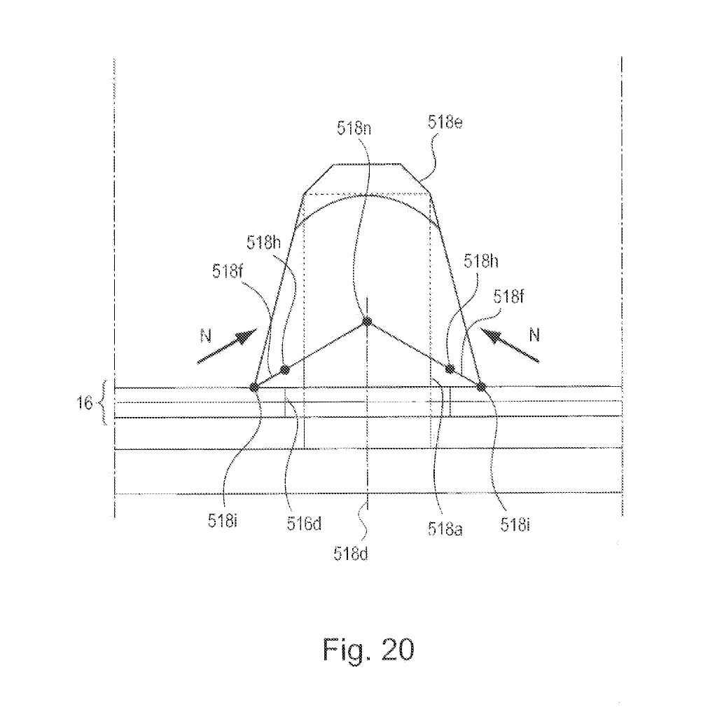

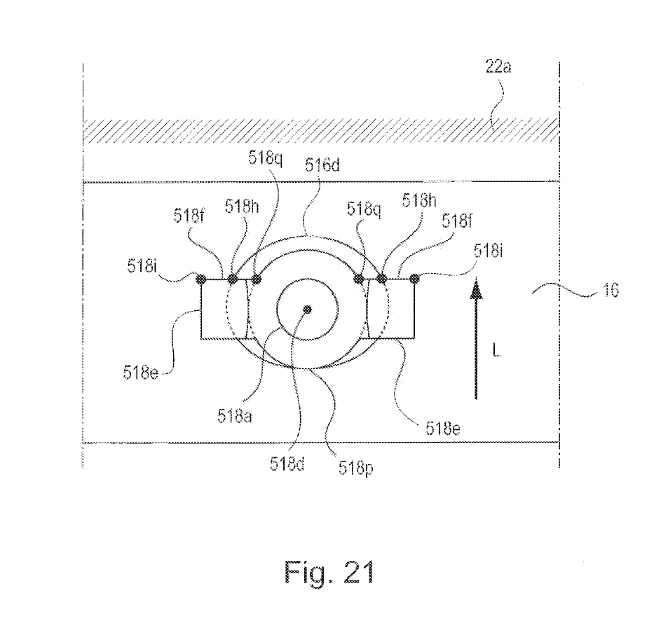

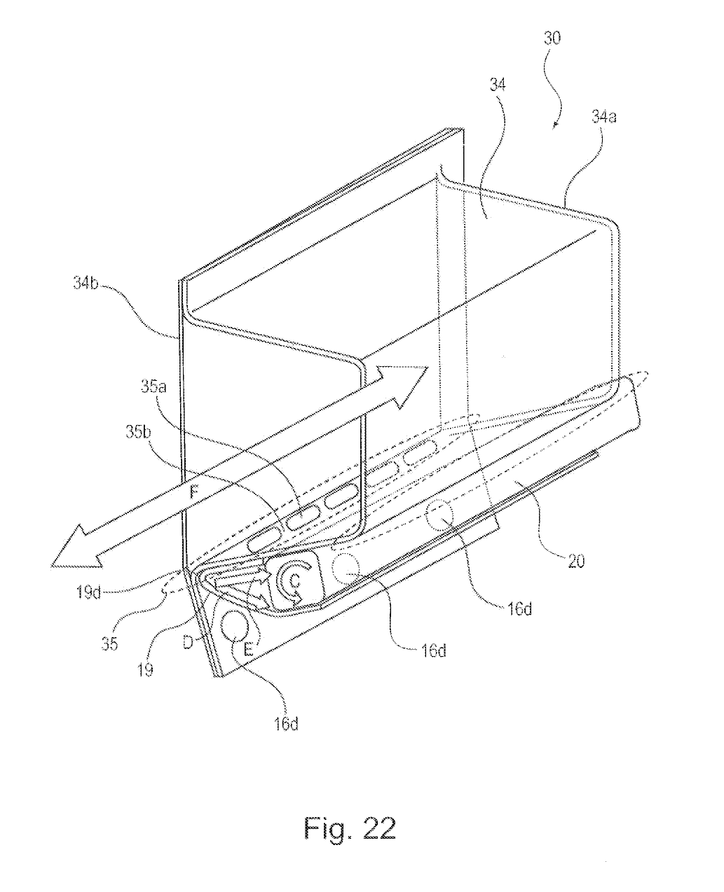

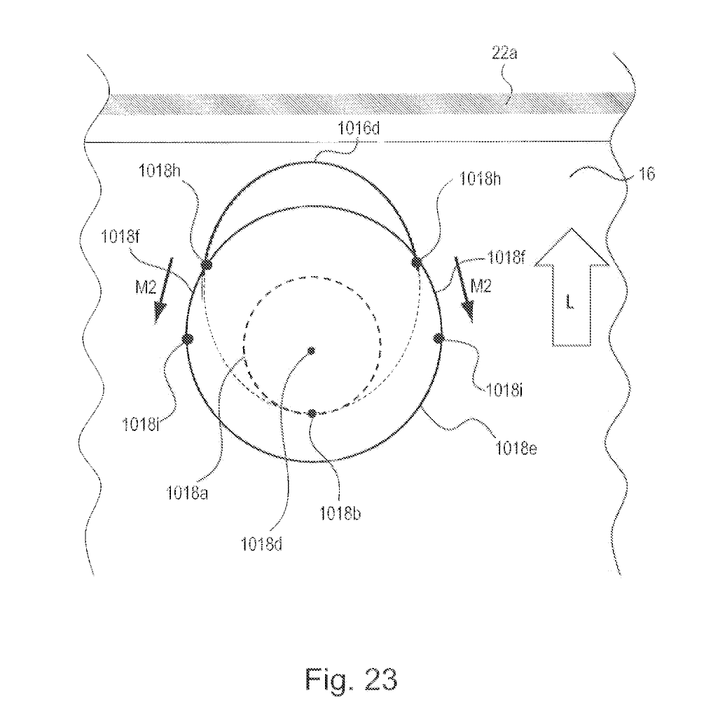

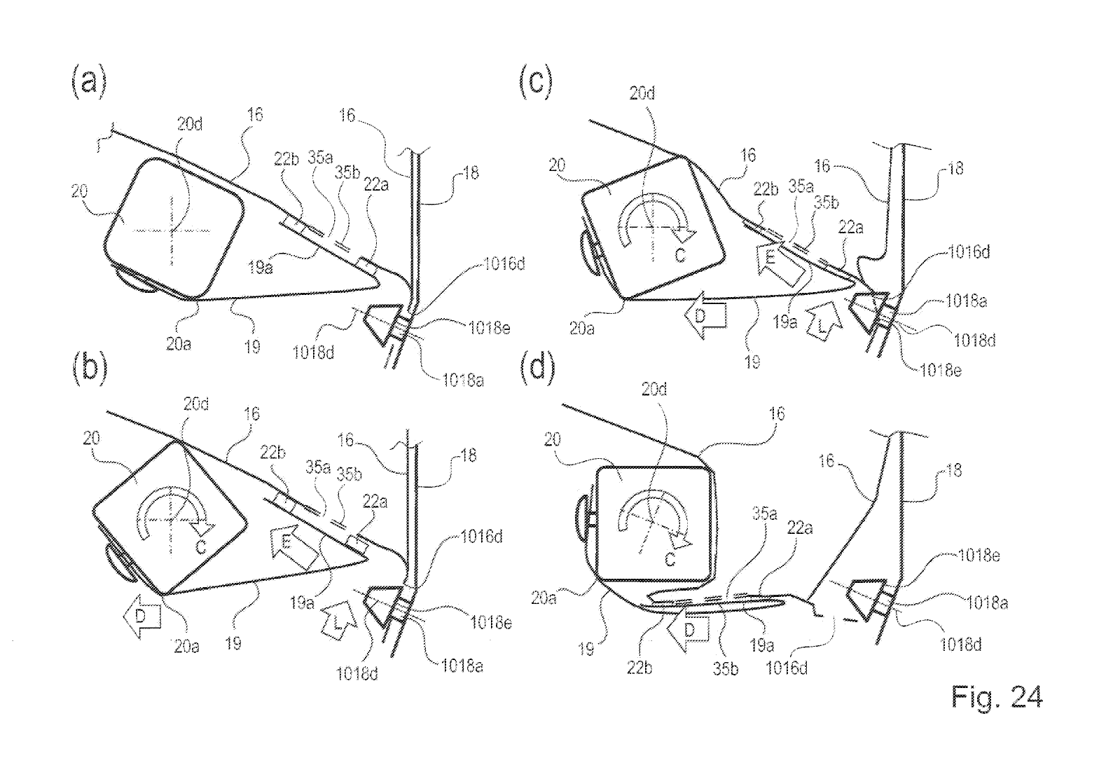

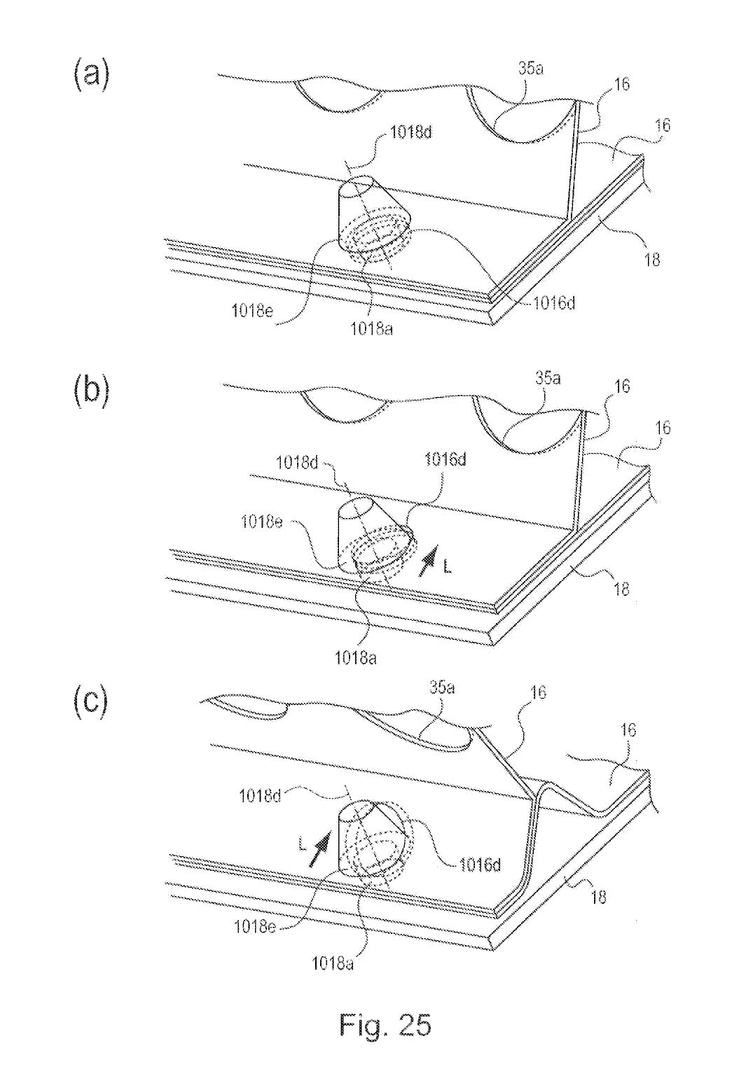

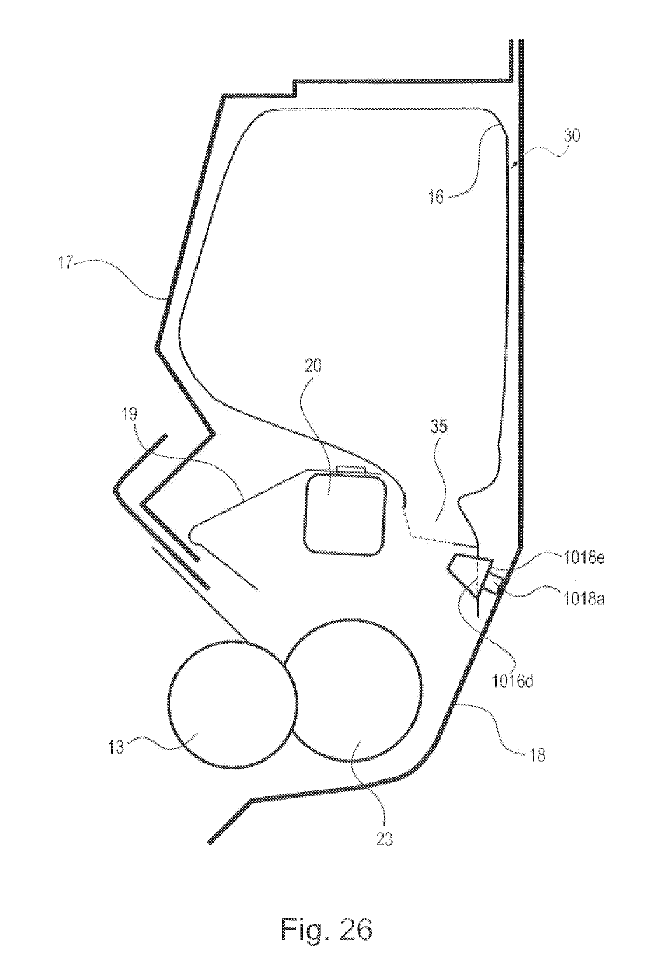

Parts (a), (c) and (e) of FIG. 8 are sectional views for illustrating an unsealing process of the opening of the flexible container by the unsealing member in First Embodiment, and (b), (d) and (f) of FIG. 6 are partly enlarged views of (a), (c) and (e) of FIG. 8, respectively.

Part (a) of FIG. 9 is a sectional illustration showing a (spacing) distance between the retaining portion and a first bonding portion on a movement path in First Embodiment, and (b) of FIG. 9 is a sectional illustration showing a distance between the retaining portion and the first bonding portion on the movement path in the case where a shape of a developing bag having flexibility is deformed.

FIG. 10 is a schematic view of the retaining portion in First Embodiment as seen by projecting the retaining portion on the plane perpendicular to the axis of the fixing shaft portion, and is illustration showing a state in which an outer end portion of a locking edge line outside an edge portion of a fastening hole has a distance closer to the first bonding portion than a locking portion, where the edge portion of the fastening hole is locked.

Part (a) of FIG. 11 is a schematic view of a retaining portion of a developer accommodating unit according so the present invention in Second Embodiment, as seen by projecting the retaining portion on, a plane perpendicular to an axis of a fixing shaft portion, and is illustration showing a state in which an outer end portion of a locking edge line outside an edge portion of a fastening hole has a distance closer so the first bonding portion than a locking portion where the edge portion of the fastening hole is looked, and (b) of FIG. 11 is a schematic view of a retaining portion of a developer accommodating unit according to she present invention in Third Embodiment as seen by projecting the retaining portion on a plane perpendicular to an axis of a fixing shaft portion, and is illustration showing a state in which an outer end portion of a locking edge line outside an edge portion of a fastening hole has a distance closer to the first bonding portion than a locking portion where the edge portion of the fastening hole is locked.

Part (a) of FIG. 12 is a schematic view of a retaining portion of a develop accommodating unit according to the present invention in Fourth Embodiment as seen by projecting the retaining portion on a plane perpendicular to an axis of a fixing shaft portion, and is illustration showing a state in which an outer end portion of a locking edge line outside an edge portion of a fastening hole has a distance closer to the first bonding portion than a locking portion where the edge portion of the fastening hole is locked, and (b) and (c) of FIG. 12 are partly enlarged views of (a) of FIG. 12.

Part (a) of FIG. 13 is a schematic view of a ret a living portion of a developer accommodating unit according to the present invention in Fifth Embodiment as seen by projecting the retaining portion on a plane perpendicular to an axis of a fixing shaft portion, and is illustration showing a state in which an outer end portion of a locking edge line outside an edge portion of a fastening hole has a distance closer to the first bonding portion than a locking portion where the edge portion of the fastening hole is locked, and (b) and (c) of FIG. 13 are partly enlarged views of (a) of FIG. 13. Part (d) of FIG. 13 is a schematic view of a retaining portion of a developer accommodating unit according to the present invention in Sixth Embodiment as seen by projecting the retaining portion on a plane perpendicular to an axis of a fixing shalt portion, and is illustration showing a state in which an outer end portion of a locking edge line outside an cage portion of a fastening hole has a distance closer to the first bonding portion than a locking portion where the edge portion of the fastening hole is locked, and (e) of FIG. 13 is a partly enlarged view of (d) or FIG. 13.

FIG. 14 is a perspective illustration showing a state in which in a developer accommodating unit according to the present invention in Seventh Embodiment, an outer end portion, of an locking edge line of a retaining portion, outside an edge portion of a fastening hole is projected toward the fastening hole, with respect to an axial direction of a fixing shaft portion, more than a locking portion where the edge portion of the fastening hole is locked.

FIG. 15 is an illustration showing a state of the retaining portion in Seventh Embodiment as seen by projecting the retaining portion on a plane perpendicular to an axis of the fixing shaft portion.

FIG. 16 is a sectional illustration showing a state in which, an outer end portion, of an locking edge line of a retaining portion, outside an edge portion of a fastening hole is projected toward the fastening hole, with respect to an axial direction of a fixing shaft portion, more than a locking portion where the edge portion of the fastening hole is locked in Seventh Embodiment.

FIG. 17 is a schematic view of a retaining portion of a developer accommodating unit according to the present invention in Eighth Embodiment as seen by projecting the retaining portion on a plane perpendicular to an axis of a fixing shaft portion, and is illustration showing a state in which an outer end portion of a locking edge line outside an edge portion of a fastening hole has a distance closer to the first bonding portion than a locking portion where the edge portion of the fastening hole is locked.

FIG. 18 is a perspective illustration showing a state in which in a developer accommodating unit according to the present invention in Ninth Embodiment, an outer end portion, of an locking edge line of a retaining portion, outside an edge portion of a fastening hole is projected toward the fastening hole, with respect to an axial direction of a fixing shaft portion, more than a locking portion where the edge portion of the fastening hole is looked.

FIG. 19 is a schematic view of a retaining portion in Ninth Embodiment as seen by projecting the retaining portion on a plane perpendicular to an axis of a fixing shaft portion, and is illustration showing a state in which an outer end portion of a locking edge line outside an edge portion of a fastening hole and a looking portion where the edge portion of the fastening hole is locked have the same distance so the first bonding portion and in which an outer peripheral surface of the fixing shaft portion and she locking edge line of the retaining portion contact each other.

FIG. 20 is a sectional illustration showing a state in which, an outer end portion, of an locking edge line of a retaining portion, outside an edge portion of a fastening hole is projected coward the fastening hole, with respect to an axial direction of a fixing shaft portion, more than a locking portion where the edge portion of the fastening hole is locked in Ninth Embodiment.

FIG. 21 is a schematic view of a retaining portion of a developer accommodating unit according to the present invention in Tenth Embodiment as seen by projecting the retaining portion on a plane perpendicular to an axis of a fixing shaft portion, and is illustration showing a state in which an outer end portion of a locking edge line outside an edge portion of a fixing and a locking portion where the edge portion of the fastening hole is locked have the same distance to the first bonding portion and in which an outer peripheral surface of the fixing shaft portion is projected from the locking edge line of the retaining portion.

FIG. 22 is a perspective illustration showing a structure of a developer accommodating unit according to the present invention in Eleventh Embodiment.

FIG. 23 is an illustration showing a state of a retaining portion in a comparison example as seen by projecting the retaining portion on a plane perpendicular to an axis of a fixing shaft portion.

Parts (a) to (d) of FIG. 24 are sectional illustrations showing an unsealing process for illustrating that unsealing is difficult when the retaining portion in the comparison example is used.

Parts (a) to (c) of FIG. 25 are perspective illustrations showing the unsealing process for illustrating that the unsealing is difficult when the retaining portion in the comparison example is used.

FIG. 26 is a sectional illustration showing a state in which when the retaining portion in the comparison example is used, a fastening hole is disengaged from the retaining portion to unseal a flexible container and then the flexible container is deformed, so that a developer cannot be stably supplied to a developer supplying roller.

### DESCRIPTION OF THE PREFERRED EMBODIMENTS

Embodiments of a developer accommodating unit according to the present invention will be specifically described with reference to the drawings.

### Embodiment 1

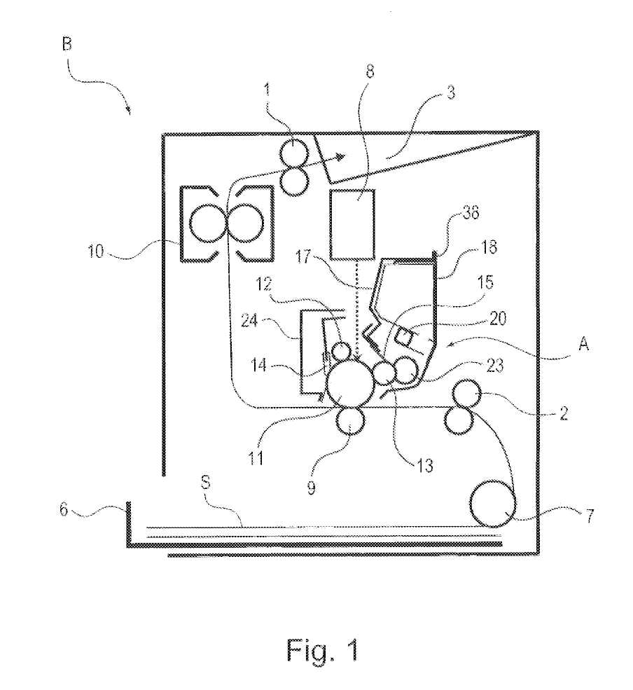

First, with reference to FIGS. 1 to 10, a constitution of a developer accommodating unit according to the present invention in First Embodiment will be described.

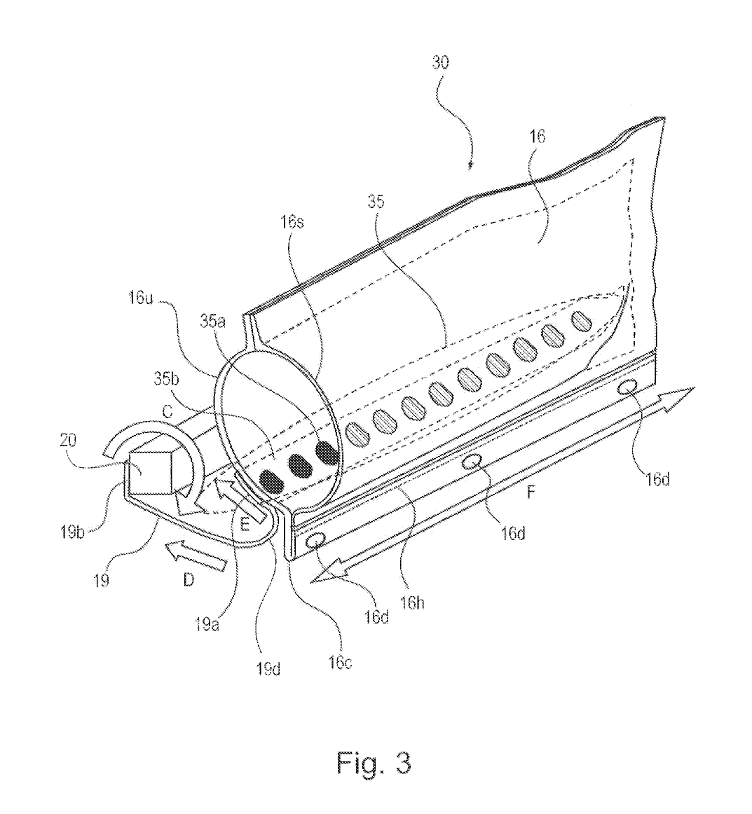

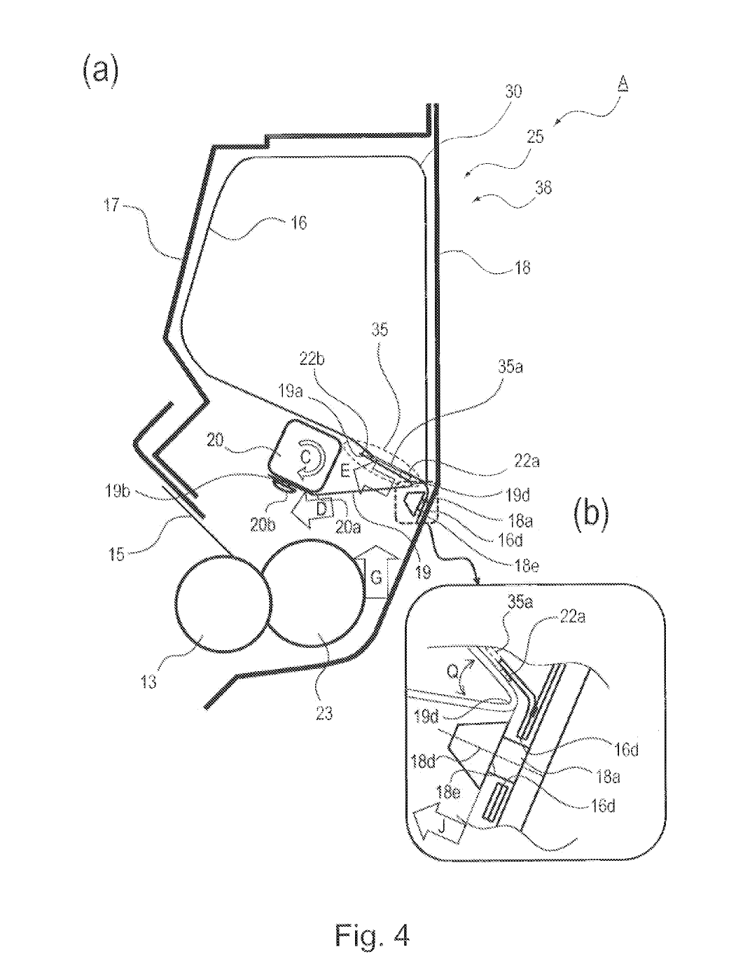

As shown in FIG. 3, a developer accommodating container 30 includes a developing bag 16 as a flexible container which accommodates at least a developer (toner, carrier and the like) and which is provided with an opening 35a for permitting discharge of the developer. The developer accommodating container 30 further includes a sealing portion 19 for sealing the opening 35a, provided in the developing bag 16, for discharging the developer, and includes a sealing member 19, mounted on the developing bag 16, capable of exposing the opening 35a by being moved.

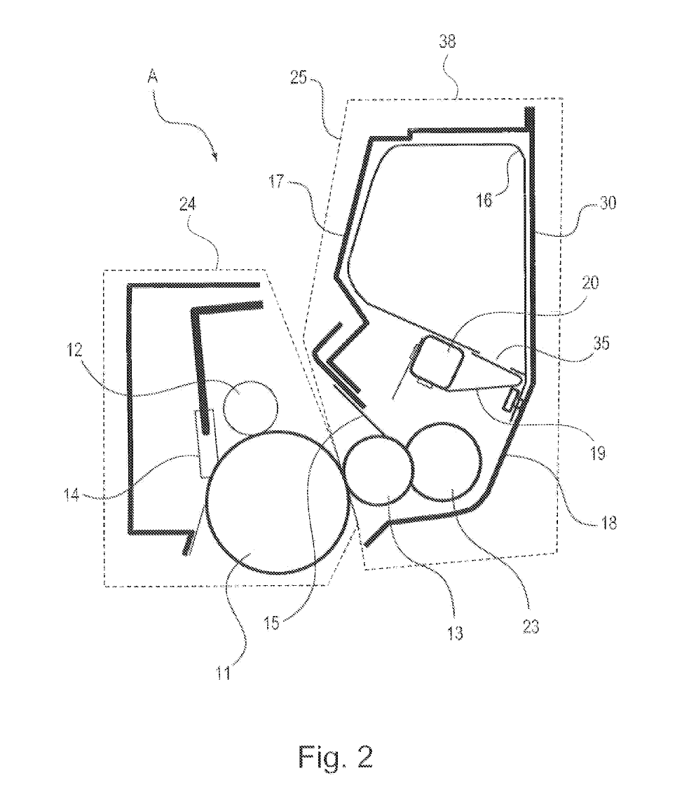

FIG. 1 is a sectional illustration showing a structure of an image forming apparatus B to which a developer accommodating unit 25 according to the present invention is applicable. FIG. 2 is a sectional illustration showing a structure of a process cartridge A including the developer accommodating unit 25 according to the present invention.

### <Process Cartridge>

As Shown in FIGS. 1 and 2, the Process cartridge A includes a photosensitive drum 11 as an image bearing member on which surface an electrostatic latent image depending on image information is to be formed, and includes an image forming process means actable on the photosensitive drum 11. Here, as the image forming process means, e.g., a charging roller 12 as a charging means for electrically charging the surface of the photosensitive drum 11 is used.

Further, the process cartridge A includes a developing device 38 as a developing means for forming a toner image on the surface of the photosensitive drum 11 by supplying a toner to the electrostatic latent image formed by subjecting the surface of the photosensitive drum 11, electrically charged uniformly by the charging roller 11, to exposure to light depending on the image information by an exposure device 8 as an exposure means. The process cartridge A further includes a cleaner unit 24 including a cleaning blade 14 as a cleaning means for removing the developer remaining on the surface of the photosensitive drum 11.

The process cartridge A in this embodiment includes, as shown in FIG. 2, at a periphery of the photosensitive drum 11, the charging roller 12 and the cleaning unit 24 including the cleaning blade 14 having elasticity. Further, the process cartridge A includes she developing device 38 including a first frame 17 and a second frame 18. By the first frame 17 and the second frame 18, an unsealing member 20 for moving a sealing member 19 and the developer accommodating container 30 are accommodated.

The process cartridge A integrally includes she cleaner unit 24 and the developing device 38 and is, as shown in FIG. 1, constituted so as to be detachably mountable to a main assembly of the image forming apparatus B. The developing device 18 includes a developing roller 13 as a developer carrying member for supplying the developer to the surface of the photosensitive drum 11. The developing device 38 further includes a developing blade 15 for regulating a layer thickness of the developer on the surface of the developing roller 13, a developer supplying roller 23 for supplying the developer to the developing roller 13, and the developer accommodating container 30 for accommodating the developer. The developing roller 13 and the developing blade it are supported by the first frame 17.

### <Image Forming Apparatus>

The process cartridge A shown in FIG. 2 is mounted, in the main assembly of the image forming apparatus B and then is used for imago formation. In an image forming operation, a sheet S is fed, by a feeding roller 7, from a sheet cassette 6 mounted at a lower portion of the image forming apparatus B shown in FIG. 1. In synchronism with a feeding operation of the sheet S, the surface of the photosensitive drum 11 uniformly charged by the charging roller 12 is subjected to selective exposure to light by the exposure device 8, so that the electrostatic latent image is formed.

The developer accommodated in the developer accommodating container 30 is supplied to the developing roller 13 by the developer supplying roller 23 in a sponge-like shape, so that the developer is carried in a thin layer on the surface of the developing roller 13 by the developing blade 15.

By applying a developing bias voltage to the developing roller 13, the toner is supplied depending on she electrostatic latent image formed on the surface of she photosensitive drum 11, so that the latent image is developed into a toner image. On the other hand, the sheet S fed by the feeding roller 7 is conveyed, by a registration roller 2, to a transfer nip formed between cue photosensitive drum 11 and a transfer roller 9 in synchronism with rotation of the photosensitive drum 11.

Then, by applying a transfer bias voltage to the transfer roller 9, the toner image formed on the surface of the photosensitive drum 11 is transferred onto the sheet S conveyed to the transfer nip. The sheet S on which the toner image is transferred is conveyed into a fixing device 10, in which the toner image is heated and pressed to be fixed on the sheet S. The sheet S on which the toner image is fixed is discharged, by a discharging roller 1 onto a discharge portion 2 located at an upper portion of the image forming apparatus B.

### <Developer Accommodating Unit>

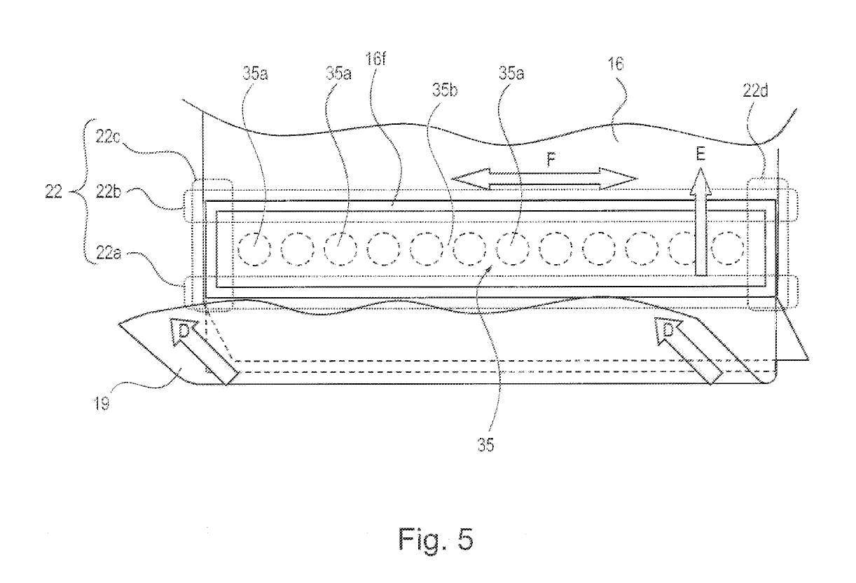

Next, with reference to FIGS. 3 to 5, a constitution of the developer accommodating unit 25 will be described. FIG. 3 is a perspective illustration showing a part of the developing bag 16 of the developer accommodating container 30 in cross section. Part (a) of FIG. 4 is a sectional illustration of the developing device 38, and (b) of FIG. 4 is a partly enlarged view of (a) of FIG. 4. The cross section shown in (a) of FIG. 4 is cut along a plane perpendicular to a rotation shaft 20d of the unsealing member 20. FIG. 5 is a perspective illustration showing a state before the developing bag 16 is unsealed.

As shown in FIG. 4, the developer accommodating unit 25 for accommodating the developer is constituted by including the developer accommodating container 30, the developing roller 13, the developing blade 15, the developer supplying roller 23 and the first and second frames 17 and 18 which support these members. The first and second frames 17 and 18 constitute in combination a frame for accommodating the developer accommodating container 30.

In this embodiment, the developer accommodating unit 25 is equivalent to the developing device 38. This is because the developer accommodating unit 25 in this embodiment is constituted by including the developing roller 13, the developing blade 15 and the developer supplying roller 23. However, a constitution in which a frame separated from the first and second frames 17 and 18 of the developer accommodating unit 25 is used to support the developing roller 13, the developing blade 15 and the developer supplying roller 23 and thus is separated from the developer accommodating unit 25 may also be employed. In this case, the developing device 38 is constituted by including the developer accommodating unit 25, the developing roller 13, the developing blade 15 and the developer supplying roller 23.

### <Unsealing Member and Developer Accommodating Container>

With reference to FIGS. 3 and 4, constitutions of the unsealing member 20 and the developer accommodating container 30 will be described.

The unsealing member 20 is mounted on the developing bag 16 and in a state in which the opening 25a is sealed includes an engaging portion 20a engaged with an engaged portion o19b of the sealing member 19 capable of exposing the opening 35a by being moved. Further, the engaging portion 19b of the sealing member 19 and the engaging portion 20b of the unsealing member 20 are engaged with each other, so that the unsealing member 20 and the developing bag 10 provided in the developer accommodating container 30 are connected.

### <Structure of Developing Bag>

As shown in FIGS. 3 and 4, the developing bag 16 is constituted by a bag-like elastic member deformable in shape and accommodates the developer therein. The developing bag 16 includes a discharge portion 23 for permitting discharge of the accommodated developer, and the discharge portion 35 is provided with a plurality or openings 35a through which the developer is to be discharged.

As shown in FIG. 5, a periphery of the discharge portion 35 of the developing bag 16 is continuously surrounded by the unsealing member 19 and is bonded unsealably by a bonding portion 22. As a result, the develops dated in the developing bag 16 is confined.

As shown in FIG. 3, the developing bag 16 is constituted by bonding a sheet 16a including the discharge portion 33 and a sheet 16s with no discharge portion 35 to each other. Further, the developing bag 16 includes a fastening hole 16d into which a fixing shaft portion 18a provided on the second frame 18 is to be inserted and fixed.

### <Bonding Portion of Developing Bag>

As shown in FIG. 5, the bonding portion 22 for unsealably bonding the periphery of the discharge portion 35 of the developing bag 16 includes a first bonding portion 22a and a second bonding portion 22b which are provided along an arrow F direction of FIG. 5 which is a longitudinal direction of the bonding portion 22. The bonding portion 22 further includes a third bonding portion 22c and a fourth bonding portion 22d which are provided along an arrow E direction of FIG. 5 which is a widthwise direction of the bonding portion 22. The openings 35a are surrounded by the first to fourth bonding portions 22a to 22d in a rectangular shape to seal the discharge portion 35.

The sealing member 19 is wound abound trio unsealing member 20 rotationally driven in an arrow C direction of FIG. 3, thus being pulled in an arrow D direction of FIGS. 3 and 5. Then, of the first bonding portion 22a and the second bonding portion 22b which are welded with respect to the arrow F direction (left-right direction) of FIG. 5f the first bonding portion 22a is first unsealed. Thereafter, the second bonding portion 22b is unsealed.

In this embodiment, in the case where the developing bag 16 is viewed along the surface of the sealing member 19 shown in FIG. 3, the first bonding portion 22a is located in a side close to the engaged portion 19b locked by the unsealing member 20 (or close to a fold-back portion 19d). Further, the second bonding portion 22b opposes the first bonding portion 22a via the openings 35a as shown in FIG. 5.

In this embodiment, an unsealing direction of the sealing member 19 is the arrow E direction shown in FIGS. 3 and 5. In this embodiment, the unsealing direction of she sealing member 13 is defined as follows. That is, in the case where the unsealing is effected by moving the sealing member 19, of the first bonding portion 22a and the second bonding portion 22b which oppose to each other via the openings 35a, the first bonding portion 22a is first peeled and unsealed. In this way, a direction directed from the first bonding portion 22a, which is first unsealed, toward the second bonding portion 22b is defined as the unsealing direction which is the arrow S direction shown in FIG. 5.

### <Opening of Developing Bag>

Next, with reference to FIG. 5, arrangement of the openings 35a provided at the discharge portion 35 of the scaling member 19 will be described. The sealing member 19 seals the openings 35a. The sealing member 19 is pulled by being wound abound the rotationally driven unsealing member 20 to be moved in the arrow D direction, thus exposing the openings 35a.

By the movement of the sealing member 19 in the arrow D direction of FIG. 5, the exposure of the openings 35a is advanced in the unsealing direction which is the arrow E direction of FIG. 5. The plurality of openings 35a which are through holes are formed with predetermined pitches with respect to she arrow F direction of FIG. 5 perpendicular to tire unsealing direction (arrow E direction) of FIG. 5. The respective adjacent openings 35a are spaced by a plurality of connecting portions 35b, so that a predetermined tensile strength of the developing bag 16 is ensured.

The sealing member 19 has a constitution in which the sealing member 19 is wound up by rotating the unsealing member 20, and the arrow F direction along which the plurality of openings 35a are arranged in a rectilinear shape is parallel to an axial direction of the rotation shaft 20d of the unsealing member 20. Further, also a rotational axis direction of the developing roller 13 shown in FIG. 4 is parallel to the arrow F direction of FIG. 3. The rotational axis direction of the developing roller 13 and the arrow F direction along which the plurality of openings 35a are arranged in the rectilinear line shape are made parallel to each other, so that when, the developer in the developing bag 16 is discharged through the openings 35a, the developer is supplied uniformly over the rotational axle direction (longitudinal direction) of the developing roller 13.

### <Sealing Member>

As shown in FIGS. 3 and 4, the sealing member 19 includes the sealing portion 19a for sealing (covering) the developing bag 16 to confine the developer in the developing bag 16 before use of the process cartridge A and includes the engaged portion 19b engaged with the unsealing member 20, and is formed in a sheet shape.

The engaging portion 19b is engaged with the unsealing member 20 for exposing the openings 35a by being rotated to move the sealing member 19. The unsealing member 20 in this embodiment is constituted by the rotation shaft 20d rotatably provided, in the second frame 18.

Further, the sealing member 19 includes the fold-back portion 19d folded back at a portion between the sealing portion 19a and the engaged portion 19d. The fold-back portion 19d may be provided with a fold or with no fold. A fold-back angle Q of the fold-back portion 19d of the sealing member 19 shown in (b) of FIG. 4 may preferably be 90 degrees or less. A materiel for the sealing member 19 is constituted by a laminate material having a sealant layer which is easily unscalable, and its base material is polyethylene terephthalate (PET), polyethylene, polypropylene or the like. A thickness of the base material may appropriately be selected from a range of 0.03 mm to 0.15 mm.

### <Unsealing Member>

The unsealing member 20 applies a force to the sealing member 19 to more the sealing member 19, so that the sealing portion 19a is peeled, off from the openings 35a of the developing bag 16 to unseal the openings 35a. The unsealing member 20 includes an unshown supporting portion which has a shaft shape and which is rotatably supported by the second frame 18 at its end portions, and includes the engaging portion 20b for fixing she engaged portion 19b of the sealing member 19.

As shown in (b) of FIG. 9 the unsealing member 20 is provided, with respect to a direction of an axis 18d of the fixing shaft portion 18a provided to stand at an inner surface of the second frame 18, toward an end of the fixing shaft portion 18a remote from the second frame 18. Further, the unsealing member 20 is disposed at a positron in a side where a retaining portion 18e for preventing the fixing shaft portion 18a from being disengaged, from the fastening hole 16d of the developing bag 16 (in a side of an arrow J direction of (b) of FIG. 4).

### <Fixing Shaft Portion and Retaining Portion>

Next, with reference to FIGS. 3, 4 and 5 to 10, constitutions of the fixing shaft portion 18a provided to stand at the inner surface of the second frame 18 and the retaining portion 18e, which is provided at the end of the fixing shaft portion 18a, for preventing the fixing shaft portion 18a from, being disengaged from the fastening hole 16d of the developing bag 16 will be described.

FIG. 6 is an illustration as seen by projecting the retaining portion 18e on a plane perpendicular to the axis 18d of the fixing shaft portion 18a. Parts (a) to (c) of FIG. 7 are perspective views for illustrating a state in which an edge portion of the fastening hole 16d rides over the retaining portion 18e by its elastic deformation to lock the fixing shaft portion 18e inserted into the fastening hole 16d. Parts (a) to (f) of FIG. 8 are sectional views for illustrating a process of unsealing the openings 35a of the developing bag 1G by the unsealing member 20.

Part (a) of FIG. 9 is a sectional illustration showing an example of a (spacing) distance K between the retaining portion 18e and the first bonding portion 22a on a movement path, and (b) of FIG. 9 is a sectional illustration showing an example of the distance K between the retaining portion 18e and the first bonding portion 22a on the movement, path in the case where a shape of the developing bag 16 having flexibility is deformed.

FIG. 10 is a schematic view of the retaining portion 18e as seen by projecting the retaining portion 18e on she plane perpendicular to the axis 18d of the fixing shaft portion 18a, and is illustration showing a state in which an outer end port icon 181 of a rectilinear locking edge line 18f outside an edge portion of the fastening hole 16d has a distance closer to the first bonding portion 22a than a locking portion 18h where the edge portion of the fastening hole 16d is locked.

As shown in FIG. 4, the developing bag 16 is provided with the fastening hole 16d for looking and fixing the fixing state portion 18a provided to stand at the inner surface of the second frame 18. An edge portion of the fastening hole 16d rides over the retaining portion 18e by its elastic deformation to lock the fixing shaft portion 18a inserted into the fastening hole 16d.

When the retaining portion 18e is, as shown in FIGS. 6 and 7, projected on a plane perpendicular to the axis 18d of the fixing shaft portion 18a, the retaining portion 18e has a shape such that a trapezoidal recessed portion is formed as a part of a rectangular shape having an outer configuration larger than a diameter of the edge portion of the fastening hole 16d of the developing bag 16. Further, the locking edge line 18f for being locked by the edge portion of the fastening hole 16d is formed in a rectilinear shape.

Next, with reference to FIG. 7, a method of locking and fixing the fixing shaft portion 18a, provided to stand at the inner surface of the second frame 18, by being inserted into the fastening hole 16d provided in the developing bag 16 will be described. The fastening hole 16d provided in the developing bag 16 is, as shown in FIG. 3, constituted by making a through hole in a bonding portion 16c between the sheet 16u and the sheet 16s which form the developing bag 16. The edge portion of the fastening hole 16d is also an elastically deformable member similarly as the developing bag 16.

First, as shown in (a) of FIG. 7, the fastening hole 16d of the developing bag 16 is moved from an end portion side (upper side of the figure) in an arrow Y direction in the figure to insert the fixing shaft portion 18a into the fastening hole 16d. Next, as shown in (b) of FIG. 7, the edge portion of the fastening hole 16d rides over the retaining portion 18e by being expanded based on its elastic deformation, so that the fixing shaft portion 18a is inserted into the fastening hole 16d as shown in (c) of FIG. 7. After the edge portion of the fastening hole 16d rides over the retaining portion 18e by its elastic deformation, as shown in (c) of FIG. 7, the edge portion of the fastening hole 16d as contracted so that its shape is restored to the shape, shown in (a) of FIG. 7, before the edge portion of the fastening hole led rides over the retaining portion 18e. As a result, the fixing shaft portion 18a is locked and fixed by the fastening hole 16d at the retaining portion 18e in a state in which the fixing shaft portion 18a is inserted into the fastening hole 16d.

In this embodiment, when the developing bag 16 is fixed to the second frame 18, a special cool for thermal caulking or ultrasonic caulking is not required, and an additional member such as a solvent, an adhesive or double-side tape is also not required. Thus, the developing bag 16 can be fixed to the second frame 18.

The fastening hole loci receives a force when the sealing member 19 is unsealed (peeled) from the developing bag 16. The fastening hole 16d is, as shown in FIG. 3, provided at a plurality of positions at predetermined pitches with respect to a direction parallel, to the arrow F direction in which the plurality of openings 35a are disposed. These fastening holes 16d are provided in the neighborhood of the openings 35a. The fixing shaft portion 18a provided to stand at the inner surface of the second frame 18 is inserted into the fastening hole 16d to be engaged in the fastening hole 16d, and thus the fixing shaft portion 18a is locked by the fastening hole 16d at the retaining portion 18e, so that movement of the developing bag 16 in a direction perpendicular to the axis 18d of the fixing shaft portion 18a is suppressed.

Further, at the end of the fixing shaft portion 18a, the retaining portion 18e having an outer peripheral diameter larger than the (inner peripheral) diameter of the fastening hole 16d is provided. By the retaining portion 18e and the inner surface of the second, frame 16, the edge portion, of the fastening hole 16d is sandwiched. As a result, the movement of the developing bag 16 in the direction of the axis 18d of the fixing shaft portion 18a is suppressed.

As shown in FIG. 4, when the unsealing member 20 is rotated about the rotation shaft 20d in the arrow C direction to wind the sealing member 19 around the outer peripheral surface of the unsealing member 20 and thus the sealing member 19 is pulled in the arrow D direction of FIG. 4, the sealing portion 19a or the sealing member 19 is peeled from the developing bag 16. At this time, when the developing bag 16 is pulled in the arrow D direction via the sealing member 19, as shown in (c) and (d) of FIG. 9, a force for pulling, in the arrow D direction of (c) of FIG. 8, the fastening hole 16a of the developing hag 16 into which the fixing shaft portion 18a is inserted is exerted on the fastening hole 16d. Then, the developing bag 16 is pulled in the arrow D direction of (c) of FIG. 8 so that its edge portion locked by the retaining portion 18e provided at the end of the fixing shaft portion 18a is moved toward a force application point portion 20a where the unseating member 20 winds the seating member 19.

When the developing bag 16 is pulled in the arrow D direction of (c) of FIG. 8, the edge portion of the fastening hole 16d is as shown in FIG. 6, pulled in an arrow L direction (predetermined direction) perpendicular to the arrow F direction, so that the edge portion of the fastening hole 16d abuts against a rear end portion 18b, with respect to the arrow L direction, of the fixing shaft portion 18a having an elliptical shape in cross section and then is moved until the edge portion of the fastening hole 16d abuts against the retaining portion 18e.

As shown is FIG. 6, the edge portion of the fastening hole 16d in the leading end portion side of the developing bag 16 with respect to the arrow L direction abuts against the locking edge line 18f of the retaining portion 18e disposed in the leading end portion side with respect to tire arrow L direction, thus being locked.

In this embodiment, as shown in FIG. 6, when the retaining portion 18e is projected on a plane perpendicular to the axis 18d of the fixing shaft portion 18a, the locking edge line 18f of she retaining portion 18e for locking the edge portion of the fastening hole 16d during the unsealing of the sealing member 19 is considered. The outer end portion 18i, of the locking edge line 18e, outside the edge portion of the fastening hole led is disposed downstream of the locking portion 18h, where the edge portion of the fastening hole 16d is locked, with respect to the arrow L direction (predetermined direction) of FIG. 6 which is a pulling direction of the edge portion of the fastening hole 16d.

In such a shape of the retaining portion 18e, the outer end portion 18i, outside the edge portion of the fastening hole led, on the locking edge line 181 has a shorter distance to the first bonding portion 22a than the locking portion 18h where the edge portion of the fastening hole 16d is locked.

As shown in FIG. 10, the case where the fastening hole 16d has a shapes such that the edge portion of the fastening hole 16d has play with respect to the fixing shaft portion 18a in the arrow F direction of FIG. 10 is considered. In that case, tire outer end portion 18i is disposed downstream (in the upper side in FIG. 10), with respect to the arrow L direction of FIG. 10 as the pulling direction of the edge portion of the fastening hole 16d, of the locking portion where the edge portion of the fastening hole 16d on the locking edge line 19f of the retaining portion 18e. The outer end portion 18i of the locking edge line 18f is dispensed outside the edge portion of the fastening hole 16d. Then, the shape such that the distance from the outer end portion 18i to the first bonding portion 22a is smaller than the distance from the locking portion 18h to the first bonding portion 22 will be described.

There is the case where the edge portion of the fastening hole has play with respect to the fixing shaft portion 18a in the arrow F direction of FIG. 10. In that case, the distance to the first bonding portion 22a is shorter at a position in which the locking portion 18h, where the edge portion of the fastening hole 16d is locked, on the locking edge line 18f of the retaining portion 18e is capable of being remotest to the fixing shaft portion 18a than at a position in which the looking portion 18h is capable of being closest to the fixing shaft portion 18a. The outer end portion 18i is disposed outside of the edge portion of the fastening hole 16d on the locking edge line 18f.

Furthers the shorter distance K from the first bonding portion 22a refers to, as shown, in (a) and (b) of FIG. 9, the distance K from the position on the locking edge line 18f to the first bonding portion 22a on a path along the surface of the developing bag 16.

There is the case where the shape of the flexible developing bag 16 is deformed as shown in (b) of FIG. 9. Also in that case, similarly as in the case of (a) of FIG. 9, the distance K to the first bonding portion 22a is shorter at the outer end portion 18k outside the edge portion of the fastening hole 16d on the locking edge line 18f of the retaining portion 18e than at the locking portion 18h where the edge portion of the fastening hole 16d on the locking edge line 18f.

In this way, the fixing shaft portion 18a provided to stand at the inner surface of the second frame 18 and the retaining portion 16e provided ac the end of the fixing shaft portion 18a support the developing bag 16 against a pulling force of the sealing member 19 when the sealing member 19 for the developing bag 16 is pulled to unseal the openings 35a.

### <Unsealing Operation of Developing Bag>

Next, with reference to FIGS. 4, 6 and 8, an unsealing operation of the sealing portion 19a from the developing bag 16 will be described.

The pulling force for pulling the sealing member 19 in the arrow D direction of (a) of FIG. 9 is applied to the force application point portion 20a where a corner portion of the unsealing member 20, having the rectangular shape in cross section, rotated, about the rotation shaft in she arrow C direction of (a) of FIG. 4 in order to unseal the seating portion 19a for the developing bag 16 contacts the sealing member 19. The developing device 38 includes the fining shaft portion 16a, provided to stand at the inner surface of the second frame 18 locked by being inserted into the fastening hole 16d of tire developing bag 16 pulled by the sealing member 19 wound, by the unsealing member 20 and includes the retaining portion 18e provided at the end of the fixing shaft portion 18a.

The force application point portion 20a where the corner portion of the unsealing member 20 contacts the sealing member 19 is, of portions where the sealing member 19 and the corner portion of the unseating member 20 contact each other when the sealing portion 19a for the developing bag 16 is unsealed, a portion closest to the first bonding portion 22a on the sealing member 19.

First, as shown in (a) of FIG. 4, a rotational driving force is transmitted to the unsealing member 20 by an unshown driving means provided in the main assembly of the image forming apparatus B, so that the unsealing member 20 is rotated about the rotation shaft 20d in the arrow C direction in (a) of FIG. 4. Then, the rotation of the unsealing member 20 is advanced, so that the sealing member 19 including the engaged portion 19b locked by the engaging portion 20b of the unsealing member 20 is pulled in the arrow D direction of (a) of FIG. 4 to start tire unsealing at the first bonding portion 22a. A state immediately before the unsealing; at the first bonding portion 22a is shown in (a) and (b) of FIG. 8.

As shown in (c) and (d) of FIG. 6, with the rotation of the unsealing member 20, the sealing member 19 is pulled in the arrow D direction of (c) of FIG. 8. The sealing member 19 fined on the unsealing member 20 at she engaged portion 19b is pulled in the arrow D direction of (c) of FIG. 8 by the pulling force acting on the force application point portion 20a as the contact portion between the corner portion of the unsealing member 20 and the sealing member 19. When she sealing member 19 is pulled in the arrow D direction of (c) of FIG. 8, the developing bag 16 is pulled in the arrow D direction of (c) of FIG. 8 via the first bonding portion 22a. At this time, the edge portion of the fastening hole led of the developing bag 16 is pulled in the arrow L direction of (d) of FIG. 3.

In this case, the edge portion of the fastening hole 16d is contacted to and locked by a rear end portion 18b of the fixing staff portion 18a and the locking edge line 18f of the retaining portion 18e, and its movement is suppressed, so than the developing bag 16 is pulled toward the force application point portion 20a. Then, in cross section distance the rotation shaft 20d of the unsealing member 20 shown in (c) of FIG. 8, the first bonding portion 22a nerves so as to approach a rectilinear line connecting the force application point portion 20a with the locking portion 18h on the locking edge line 18f. Further, the sealing member 19 is folded, back at the fold-back portion 19d between the first bonding portion 22a and the engaged portion 19b. For this reason, the pulling force acts on the first bonding portion 22a so as to perform inclination peeling of the first bonding portion 22a in the arrow D direction of (c) of FIG. 8, so that the first branding portion 22a is peeled to start the unsealing of the openings 35a.

A state in which, after the peeling of the first bonding portion 22a is performed to unseal the sealing member 19 and thus the openings 35a are exposed, peeling of the second bonding portion 28b is to be started is shown in (e) and (f) of FIG. 8. Also at this time, similarly as in the case of the peeling of the first bonding portion 22a, the sealing member 19 is pulled toward the force application point portion 20a, so that the edge portion of the developing beg 16 is continuously locked by the rear end portion 18b of the fixing shaft portion 18a and the locking edge line 18f of the retaining portion 13f and thus the movement of the developing bag 16 is suppressed.

Then, in cross section perpendicular to the rotation shaft 20d of the unsealing member 20 shown in (e) of FIG. 8, the second bonding portion 22b moves so as to approach the rectilinear line connecting the force application point portion 20a with the locking portion 18h on the locking edge line 20f. Then, the pulling force acts on the second bonding portion 22b so as to per form the inclination peeling of the second bonding portion 22b in the arrow D direction of (e) of FIG. 6, so that the second bonding portion 22b is peeled and then, the sealing member 19 is disengaged from the developing bag 16 and is wound around the unsealing member 20. Thus, the unsealing of the sealing member 19 is completed, so that the developer passes through the openings 35a to be discharged into the developer accommodating container 30, thus being supplied to the developing roller 13 via the developer supplying roller 13.

In a series of steps of the unsealing operation of the sealing portion 19a, as shown in FIG. 6, when the retaining portion 18e is projected on the plane perpendicular to the axis 13d of the fixing shaft, portion 18a, the locking edge line 18f of the retaining portion 18e for locking the edge portion of the fastening hole 16d during the unsealing of the seating member 19 is considered. On the locking edge line 18f, the distance to the first bonding portion 22a from the outer end portion 18i outside the edge portion of tire fastening hole 16d is shorter than the distance to the first bonding portion 22a from the locking portion 18h where the edge portion of the fastening hole 16d is locked.

That is, the outer end portion 18i is closer to the first bonding portion 22a than the locking portion 18h in the downstream side with respect to the arrow L direction of FIG. 6 as the pulling direction of the edge portion of the fastening hole 16d. For that reason, the developing bag 16 is pulled via the searing member 19. Then, a moving force M1 directed, along the locking edge line 18f, from the outer end portion 18l outside the edge portion of the fastening hole 16d on the locking edge line 20f toward the lucking portion 18h where the edge portion of the fastening hole 16d is locked, is exerted on the edge portion of the fastening hole 16d. By this moving force M1, the edge portion of the fastening hole 16d is moved (shifted) toward the locking portion 18h. For this reason, the edge portion of the fastening hole 16e is not disengaged from the retaining portion 18e, so that it is possible to stably realise the unsealing of the openings 35a of the developing bag 16.

### Comparison Example

A problem in the case where a retaining portion 1018e having a circular truncated cone-like shape in Comparison example is used will be described below with reference to FIGS. 23 to 26. FIG. 23 is an illustration showing a state of the retaining portion 1018e in Comparison example as seen by projecting the retaining portion 1018e en a plane perpendicular to an axis 1018e of a fixing shaft portion 1018a. Parts (a) to (d) of FIG. 24 are sectional illustrations showing an unsealing process for illustrating that unsealing of the sealing portion 19a of the developing bag 16 is difficult when the retaining portion 1018e in Comparison example is used.

Parts (a) to (c) of FIG. 25 are perspective illustrations showing the unsealing process for illustrating that the unsealing of the sealing portion 19a of the developing bag 16 is difficult when the retaining portion 1018e in Comparison example is used. FIG. 26 is a sectional illustration showing a state in which when the retaining portion 1018e in Comparison example is used, a fastening hole 1016d is disengaged from the retaining portion 1018e to unseal the sealing portion 19a of the developing bag 16 and then the unsealed developing bag 16 is abnormally deformed, so that the developer cannot be stably supplied to the developer supplying roller 23.

The retaining portion 1016e in Comparison example is constituted in a perfect circular shape in cross section as shown in FIG. 23. Further, as shown in FIG. 23, when the retaining portion 1018e in Comparison example is projected on the plane perpendicular to the rotation axis 1018d of the fixing shaft portion 1018a, a locking edge line 1018f of the retaining portion 1018e for locking an edge portion of the fastening hole 1016d during the unsealing of the sealing member 19 is considered. On the locking edge line 1018f, a distance to the first bonding portion 22a from a locking portion 1018h where an edge portion of the fastening hole 1016d is locked is shorter (smaller) than a distance from an outer end portion 1018i to the first bonding portion 22a. The outer end portion 1018i is an outermost portion located outside the edge portion of the fastening hole 1016d on the locking edge line 1018f.

In this shape, as shown in (b) of FIG. 24, when the unsealing member 20 is rotated about the rotation shaft 20d in the arrow C direction of (b) of FIG. 24 to pull the sealing member 19 in the arrow D direction of (b) of FIG. 24, also the developing bag 16 is pulled in the arrow D direction of (b) of FIG. 24 via the first bonding portion 22a. Then, as shown in FIG. 23, a moving force M2 directed from the locking portion 1018h where the edge portion of the fastening hole 1016d is locked on the locking edge line 1018f of the retaining portion 1018e toward the outer end portion 1018i outside the edge portion of the fastening hole 1016d on the locking edge line 1018f is exerted, on the edge portion of the fastening hole 1016d.

As shown in FIG. 23, when the moving force M2 for moving the edge portion of the fastening hole 1016a in the direction from the locking portion 1018h on the locking edge line 1018f of the retaining portion 1018e toward the outer end portion 1018i is exerted on the edge portion of the fastening hole 1018d, the fastening hole 1018i receives the moving force M2 in the direction in which the edge portion of the fastening hole 1016d is disengaged from the retaining portion 1018e. Then, as shown in (c) of FIG. 24 and (c) of FIG. 25, the edge portion of the fastening hole 1016d is disengaged from the retaining portion 1018e from a downstream side (upper side of (c) of FIG. 24 and (c) of FIG. 25) of the fastening hole 10160 with respect to the arrow L direction.

When the unsealing member 20 is further rotated about the rotation shaft 20d in the arrow C direction of (c) of FIG. 24, as shown in (d) of FIG. 24, the edge portion of the fastening hole 1016d is completely disengaged, from the retaining portion 1018e. As a result, the unsealing of the sealing portion 19a for the developing bag 16 cannot be effected.

Or, as shown in be; of FIG. 24, (c) of FIG. 25 end FIG. 26, there is the case where the unseating of the sealing portion 19a for the developing bag 16 is completed in a state in which the edge portion, of the fastening hole 1016d in the downstream side (upper side in (c) of FIG. 24 and (c) of FIG. 25) of the arrow f, direction is disengaged from the retaining portion 1018e. In that case, as shown in FIG. 26, the developing bag 16 is placed in an abnormally deformed state. In this abnormally deformed state, a desired discharge amount of the developer through the openings 35a cannot be obtained. Further, a positional relationship between the developer supplying roller 23 and the openings 35a is different from that in a state in which the fixing shaft portion 1018a is completely locked and fixed by the fastening hole 1016d. For this reason, there arises a problem that the developer cannot be stably supplied to the developer supplying roller 23.

### Second Embodiment

Next, with reference to (a) of FIG. 11, a developer accommodating unit according to the present invention in a constitution in this embodiment will be described. Incidentally, constituent elements similar to those in the above-described First Embodiment are represented, by the same reference numerals or symbols and will be omitted from description.

In First Embodiment described above, the locking portion 18h where the edge portion or the fastening hole 16d is locked and the outer end portion 18i outside the edge portion of the fastening hole 16d on the locking edge line 18f are connected by the rectilinear line. However, the locking edge line 18 is not required to be the rectilinear line, but may also be a curved line as shown in (a) of FIG. 11.

Part (a) of FIG. 11 is a schematic view of a retaining portion 18e of a developer accommodating unit 25 in this embodiment as seen by projecting the retaining portion 18e on a plane perpendicular to an axis 18d of a fixing shaft portion 18a. At that time, a distance from an outer end portion 18i of a curved locking edge line 18f outside an edge portion of a fastening hole 16d to the first bonding portion 22b is smaller than a distance from a locking portion 18h, where the edge portion of the fastening hole 18d is locked, to the first bonding portion 22a.

When the retaining portion 18e in this embodiment is, as shown in (a) of FIG. 11, projected on the plane perpendicular to the axis 18d of the fixing shaft portion 18a, the retaining portion 18e has a shape such that a recessed portion consisting of a curved line and a rectilinear line is formed as a part of a rectangular shape having an outer configuration larger than a diameter of the edge portion of the fastening hole 16d of the developing bag 16. Further, the locking edge line 18f for being looked by the edge portion of the fastening hole 16d is formed in the curved shape. Further, a constitution in which the distance to the first bonding portion 22a from the outer end portion 18i outside the edge portion of the fastening hole 16d is shorter than the distance to the first bonding portion 22a from the locking portion 18h where the edge portion of the fastening hole 16d is locked was employed.

For example, as described later with reference to FIG. 19, there is the case where a distance from the locking portion 18h to the first bonding portion 22a is equal to a distance from the outer end portion 18i, outside the edge portion of the fastening hole 16d on the locking edge line 18f, to the first bonding portion 22a. The locking portion 18h a portion where the edge portion of the fastening hole 16d is looked. Further, there is also the case where the locking portion 18h and the outer end portion 18i are disposed at the same position with respect to the arrow L direction of (a) of FIG. 11 as the pulling direction of the edge portion of the fastening hole 16d.

Even in that case, different from Comparison example described above with reference to FIG. 23, the moving force M2 for moving the edge portion of the fastening hole 16d in the direction from the locking portion 18h, where the edge portion of the fastening, hole 16d is locked, toward the outer end portion 18i outside the edge portion of the fastening hole 16d on the locking edge line 18f is not generated. As a result, even when the developing bag 16 is pulled via the sealing member 19, the edge portion of the fastening hole 16d is not disengaged from the retaining portion 18e, so that it is possible to stably realize the unsealing of the openings 35a of the developing bag 16.

In this embodiment, the developing bag 16 is pulled via the sealing member 19. Then, a moving force M1 for moving the edge portion of the fastening hole 16d in the direction from the outer end portion 18i outside the edge portion of the fastening hole 16d on the locking edge line 20f toward the locking portion 18h where the edge portion of the fastening hole 16d is locked is generated. As a result, an effect similar to that in First Embodiment described above is obtained. Other constitutions are the same as those in First Embodiment, and a similar effect can be obtained.

### Third Embodiment

Next, with reference to (b) of FIG. 11, a developer accommodating unit according to the present invention in a constitution in this embodiment will be described. Incidentally, constituent elements similar to those in she above-described embodiments are represented by the same reference numerals or symbols and will be omitted from description.

In the above-described First and Second Embodiments, with respect to the shape of the retaining portion 18e when the retaining portion 18e is viewed by being projected on the plane perpendicular to the rotation shaft 18d of the fixing shaft portion 18a, the whole shape excluding the portion of the locking edge line 18f was constituted by the rectangular shape (in cross section). In this embodiment, the whole shape excluding the portion of the locking edge line 18f is constituted by an elliptical shape. As a result, when the edge portion of the fastening hole 16d is caused to ride over the retaining portion 18e by being expanded based on its elastic deformation, the fixing shaft portion 18a is easily inserted into the fastening hole 16d.

Part (b) of FIG. 11 is a schematic view of a retaining portion 18e of a developer accommodating unit 25 in this embodiment as seen by projecting the retaining portion 18e on a plane perpendicular to an axis 18d of a fixing shaft portion 18a. At that time, a distance from an outer end portion 18i of a rectilinear locking edge line 18f outside an edge portion of a fastening hole led to the first bonding portion 22b is smaller than a distance from a locking portion 18h, where the edge portion of the fastening hole 18d is locked, to the first bonding portion 22a.

As shown in (b) of FIG. 11, the shape of the retaining portion 18e excluding the rectilinear locking edge line 18f is not required to be the rectilinear shape as in First Embodiment shown in FIG. 6 and Second Embodiment shown in (a) of FIG. 11. As the shape of the retaining portion 18e, various shapes for permitting easy insertion of the fixing shaft portion 18a into the fastening hole 16d may appropriately be used when the edge portion of the fastening hole 16d is caused to ride over the retaining portion 18e by being expanded based en its elastic deformation.

Other constitutions are the same as those in the above-described embodiments, and a similar effect can be obtained.

### Fourth Embodiment

Next, with reference to FIG. 12, a developer accommodating unit according ire the present invention in a constitution in this embodiment will be described. Incidentally, constituent elements similar to those in the above-described embodiments are partly represented by the same reference numerals or symbols and are partly represented by different reference numerals or symbols, and will be omitted from redundant description.

Part (a) of FIG. 12 is a schematic view of left and right retaining portions 218l and 218r of a developer accommodating unit 25 in this embodiment as seen by projecting the retaining portions on a plane perpendicular to an axis 218d of a fixing shaft portion 218a. At that time, a distance from an outer end portion 218i of a rectilinear locking edge line 218f outside an edge portion of a fastening note 216d to the first bonding portion 22b is smaller than a distance from a locking portion 218h, where the edge portion of the fastening hole 218d is locked, to the first bonding portion 22a. Part (b) and (c) of FIG. 12 are partly enlarged views of (a) of FIG. 12.

In the above-described embodiments, the retaining portion 18e having the outer configuration larger than the diameter of the edge portion of the fastening hole 16d provided at the plurality of positions was provided. Further, an example in which the locking edge line 18f was provided, in each of sloes of the fixing shaft portion 18a shown in FIGS. 6 and 11 with respect to the arrow F direction was described.

In this embodiment, as shown in FIG. 12, the fastening hole 216d having a perfect circular shape is provided at a lock of positions of the developing bag 16. Trapezoidal retaining portions 218l and 218r each having the outer configuration larger than the diameter of the fastening hole 216d are provided in a projected state in the left and right sides, respectively, of the fixing shaft portion 218a provided in each of the plurality of the fastening holes 216d. By the retaining portions 218l and 218r, the edge portions of the fastening holes 216d are prevented from being disengaged from the fixing shaft portions 218a.

In this embodiment, as shown in (a) of FIG. 12, the plurality of the fixing shaft portions 218a are provided. Of these fixing shaft portions 218a, with respect to the fixing shaft portions 218a at end portions with respect to the arrow F direction of (a) of FIG. 12, the retaining portion 216l and 218r for the fixing shaft portions are disposed outside in a projected state in left and right sides, respectively, of the fixing shaft portions 218a with respect to the arrow F direction of (a) of FIG. 12. At an intermediary portion with respect to the arrow F direction of (a) of FIG. 12, the retaining portions 218l and 218r for the fixing shaft portions 218a are disposed outside in a projected state in left and right sides, respectively, of the fixing shaft portions 218a with respect to the arrow F direction of (a) of FIG. 12. The retaining portions 218l and 218r are disposed so that the number of the left-side retaining portions 218l is equal to the number of the right-side retaining portions 213r.

As shown in (a) of FIG. 12, in this embodiment, the sealing member 19 is unsealed. At that time, a shape of a rectilinear locking edge line 128f of each of the retaining portions 218l and 218r for looking the edge portions of the fastening holes 216d is similar to those in the above-described embodiments. That is, when each of the retaining portions 218l and 218r is projected on a plane perpendicular to the axis 218d of the fixing shaft portion 218a, a distance to the first bonding portion 22a from the outer end portion 218l outside the edge portion of the fastening hole 216d on the locking edge line 218f is smaller than a distance to the first bonding portion 22a from the locking portion 218h where the edge portion of the fastening hole 216d is looked.

By providing the retaining portions 218l and 218r projected to left and right outsides, respectively, of outer diameter portions of the fixing shaft portions 218a, positions where the developing bag 16 is looked at the end portions with respect to the arrow F direction of (a) of FIG. 12 can be constituted substantially similarly as in the above-described embodiments.

Further, the retaining portions 218l projected leftward from the fixing shaft portions 218a with respect to the arrow F direction of (a) of FIG. 12 and the retaining portions 218r projected, rightward from cue fixing shaft portions 218a with respect to the arrow F direction of (a) of FIG. 12 are disposed in the same manner and alternately with respect to the arrow F direction of (a) of FIG. 12.

As a result, as shown in (b) and (c) of FIG. 12, mowing forces M1 for moving the edge portions of the fastening holes 216d from the outer end portions 218i toward the locking portions 218b along fire locking edge lines 218f of the retaining portions 218l and 218r projected to the left and right outsides, respectively, of the outer diameter portions of tire fixing shaft portions 218a can be cancelled with each other with respect to the left-right direction. Further, a force for shifting the developing bag 16 in one side with respect, to the arrow F direction of (a) of FIG. 12 is not generated. Other constitutions are the same as those in the above-described embodiments, and a similar effect can be obtained.

### Fifth Embodiment

Next, with reference to (a) to (c) of FIG. 13, a developer accommodating unit according to the present invention in a constitution in this embodiment will be described. Incidentally, constituent elements similar to those in she above-described embodiments are represented by the same reference numerals or symbols and will be omitted from description.

Part (a) of FIG. 13 is a schematic view of left and right retaining portions 218l and 218r of a developer accommodating unit 25 in this embodiment as seen by projecting the retaining portions on a plane perpendicular to an axis 218d of a fixing shaft portion 218a, and is illustration showing a state in which an outer end portion 218i of a locking edge line 218f outside an edge portion of a fastening hole 218d has a distance closer to the first bonding portion 22a than a locking portion 218h where the edge portion of the fastening hole 216d is locked, and (b) and (c) of FIG. 13 are partly enlarged views of (a) of FIG. 13.

In Fourth Embodiment described above, the retaining portions 218l projected leftward from the fixing shaft portions 218a with respect to the arrow F direction of (a) of FIG. 12 are provided. Further, the retaining portions 218r projected rightward from the fixing shaft portions 218a with respect to the arrow F direction of (a) of FIG. 12. Further, the retaining portions 218l and 218r are disposed alternately with respect to the arrow F direction of (a) of FIG. 12.

In this embodiment, as shown in (a) of FIG. 13, with respect to the arrow F direction of (a) of FIG. 13, the retaining portions 218l projected leftward from the fixing shaft portions 218a are disposed from a central portion to a left-side end portion of the developing bag 16. Further, the retaining portions 218r projected rightward from the fixing shaft portions 218a are disposed from the central portion to a right-side end portion of the developing bag 16.

Further, the left-side retaining portions 218l of (a) of FIG. 13 and the right-side retaining portions 218r or (a) of FIG. 13 are disposed in the same number. In this case, as shown in (b) and (c) of FIG. 13, moving forces M1 for moving the edge portions of the fastening holes 216d from the outer end portions 218l toward the locking portions 218h airing the locking edge lines 218f of the retaining portions 218l and 216r projected to the left and right outsides, respectively, of the outer diameter portions of the fixing shaft portions 218a can be cancelled with each other with respect to the left-right direction. Further, a force for shifting the developing bag 16 in one side with respect to the arrow F direction of (a) of FIG. 13 is not generated. Other constitutions are the same as those in the above-described embodiments, and a similar effect can be obtained.

### Sixth Embodiment

Next, with reference to (d) and (e) of FIG. 13, a developer accommodating unit according to the present invention in a constitution, in this embodiment will be described. Incidentally, constituent elements similar to those in the above-described embodiments are represented by the same reference numerals or symbols and will be omitted from description.

Part (d) of FIG. 13 is a schematic view of left and right retaining portions 218l and 218r of a developer accommodating unit 25 in this embodiment as seen by projecting the retaining portions on a plane perpendicular to an axis 218d of a fixing shaft portion 218a, and is illustration showing a state in which an outer end portion 218i of a locking edge line 218f outside an edge portion of the rectangular fastening hole 218d has a distance closer to the first bonding portion 22a than a locking portion 218h where the edge portion of the fastening hole 216d is locked, and (e) of FIG. 13 is a partly enlarged view of (a) of FIG. 13.

In the above-described embodiments, with respect to all of the fixing shaft portions 18a and 218a, the fastening holes 16d and 216d were provided, respectively. In this embodiment, with respect to each of pairs of left and right retaining portions 218l and 218r which are disposed adjacently to each other, a single rectangular fastening hole 216d is provided.

As shown in (d) of FIG. 13, the retaining portions 218l projected leftward from the fixing shaft portions 218a with respect to the arrow F direction of (d) of FIG. 13 are provided. Further, the retaining portions 218r projector rightward from the fixing shaft portions 218a with respect to the arrow F direction of (d) of FIG. 13. Further, the retaining portions 218l and 218r are disposed alternately with respect to the arrow F direction of (d) of FIG. 13. Further, the pair of left and right retaining portions 218l and 218r is disposed adjacently to each other. Further, the pair of left and right retaining portions 218l and 218r is inserted into the single rectangular fastening hole 216d, so that the edge portion of the fastening hole 216d is prevented from being disengaged from the fixing shaft portions 218a.

In this embodiment, there is no need to provide the fastening holes 216d with respect to all of the fixing shaft portions 218a one by one, so that tensile strength of the developing bag 16 can be improved. Other constitutions are the same as those an the above-described embodiments, and a similar effect can be obtained.

### Seventh Embodiment

Next, with reference to FIGS. 14 to 16, a developer accommodating unit according to the present invention in a constitution in this embodiment will be described. Incidentally, constituent elements similar to those in the above-described embodiments are partly represented by the same reference numerals or symbols and are partly represented by different reference numerals or symbols, and will be omitted from redundant description.

FIG. 14 is a perspective illustration showing a state in which in a developer accommodating unit 25 in this embodiment, an outer end portion 318i, of an hocking edge line 318f of a retaining portion 318e, outside an edge portion of a fixing 316d hole is projected toward the fastening hole 316d, with respect to a direction of an axis 318d of a fixing shaft portion 318a, more than a locking portion 318h. The locking portion 318b is a portion where the edge portion of the fastening hole 316d is locked.

FIG. 15 is an illustration showing a state of the retaining portion 318e in this embodiment as seen by projecting the retaining portion 318e on a plane perpendicular to the axis 318d of the fixing shaft portion 318a. FIG. 16 is a sectional illustration snowing a state in which, the outer end portion 318i, of the locking edge line 318f of the retaining portion 318e, outside the edge portion of the fastening hole 316d is projected toward the fastening hole 316d, with respect to the direction of the axis 318d of the fixing shaft portion 318a, more than the locking portion 318h where the edge portion, of the fastening hole 316d is locked in this embodiment.

In the above-described, embodiments, the sealing member 19 is unsealed ads shown in FIG. 7. At that time, the rocking edge lines 18f, 218f and 318f of the retaining portions 18e, 218l, 218r and 318e for locking the edge portions of the fastening holes 16d, 216d and 316d are considered.

In this case, on the locking edge lines 18f, 218f and 318f, the outer end portions 18i, 218i and 318i and the locking portions 18h, 218h and 318h were disposed on the same plane with respect to the directions of the axes 18d, 218d and 318d of the fixing shaft portions 18a, 218a and 318a. The outer end portions 18i, 218i and 318i are the outermost portions disposed unseal the edge portions of the fastening holes 16d, 216a and 316d on the locking edge lures 18f, 218f and 318f. The looking portions 18h, 218h and 318h are portions where the edge portions of the fastening holes 16d, 216d and 316d are locked.

In this embodiment, as shown in FIGS. 14 and 16, the locking edge line 318f of the retaining portion 316c for preventing the edge portion of the fastening hole 316d having an elliptical shape from being disengaged from the fixing shaft portion 318a by locking the edge portion of the fastening hole 316d provided in the developing bag 16 when the sealing member 19 is unsealed is considered. A constitution in which on the locking edge line 318f, the outer end portion 318i is projected toward the fastening hole 316d side (lower side in FIG. 16) with respect to the direction of the axis 318d of tire fixing shaft portion 318a, more than the locking portion 318h where the edge portion of the fastening hole 316d is rocked is employed. The outer end portion 318i is the outermost portion disposed unseal the edge portion of the fastening hole 316d on the locking edge line 318f.

In the above-described embodiments, as shown in FIGS. 6, 10 and 11 to 13, the retaining portions 18e, 218l, 218r and 218e are projected on the planes perpendicular to the axes 18d, 18d and 318d of the fixing shaft portions 18a, 218a and 310a.

At that time, the locking edge lines 18f, 218f and 318f of the retaining portions 18e, 218l, 218r and 318e for locking the edge portions of the fastening holes 16d, 216d and 316d when the sealing member 19 is unsealed are considered.

In this case, on the locking edge lines 18f, 218f and 813f, the outer end portions 18i, 218i and 318i were disposed closer to the first bonding portion 22a than the locking portions 18h, 218h and 318h where the edge portions of the fastening holes 16d, 216d and 316d were locked. The outer end portions 18i, 218i and 318i are the outermost portions disposed unseal the edge portions of the fastening holes 16d, 216d and 316d on the locking edge lines 18f, 218f and 318f.

As a result, the developing bag 16 is pulled via the sealing member 19. Then, the edge portions of the fastening holes 16d, 216d and 316d receive the moving forces M1 directed, along the locking edge lines 18f, 218f and 318f, from the outer end portions 18i, 218i and 318i toward the locking portions 18h, 218h and 318h. The outer end portions 18i, 2181 and 318i are the outermost portions disposed unseal the edge portions of the fastening holes 16d, 216d and 316d on the locking edge lines 18f, 213f and 318f.

By these moving forces M1, the edge portions of the fastening holes 16d, 216d and 316d are shifted toward the locking portions 18h, 218h and 318h. For this reason, the edge portions of the fastening holes 16d, 216d and 316d are not disengaged from the retaining portions 18e, 218l, 218r and 318e, so that it is possible to stably realise the unsealing of the openings 35a of the developing bag 16.

In this embodiment, as shown in FIG. 15, the retaining portion 318e is projected on the plane perpendicular to the axis 316d of the fixing shaft portion 318a.

At that time, the locking edge line 318f of the retaining portion 318e for locking the edge portion of the fastening hole 316d when the sealing member 19 is unsealed are considered. On the locking edge line 318f, the outer end portion 318i, outside the edge portion of the fastening hole 316d on the locking edge line 318l, was disposed remoter from the first bonding portion 22a than the locking portion 318h where the edge portion of the fastening hole 316d was locked.

As shown in FIG. 15, the unsealing member 20 is rotated about the rotation axis 20d, so that the sealing member 19 is pulled via the sealing member 19. Then, the edge portion of the fastening hole 316d reserves a moving force M2 directed, with respect to the direction of the axis 218d of the fixing shaft portion 318a, from the locking portion 318h, where the edge portion of the fastening hole 316d is locked, toward the direction of the outer end portion 318i outside the edge portion of the fastening hole 316d on the locking edge line 318f. On the other hand, with respect to a direction perpendicular to the axis 318d of the fixing shaft portion 318a, as shown in FIG. 16, the edge portion of the fastening hole 316d receives a moving force N directed from the outer end portion 318i, outside the edge portion of the fastening hole 316d on the locking edge line 316f, toward the locking portion 318h where the edge portion of the fastening hole 316d is locked.

By the moving force N described above, a force for shifting the edge portion of she fastening hole 316d toward the fixing shaft portion 318a along the locking edge line 318f acts on she edge portion of the fastening hole 316d. Further, as described above with reference to FIG. 15, the edge portion of the fastening hole 316d receives the moving force M2 directed from the locking portion 318h toward the outer end portion 318i along the locking edge line 318f. However, the edge portion of the fastening hole 316d is nor disengaged from the retaining portion 318e. As a result, it is possible to stably realize the unsealing of the openings 35a of the developing bag 35a. Other constitutions are the same as those in the above-described embodiments, and a similar effect can be obtained.

### Eighth Embodiment

Next, with reference to FIG. 17, a developer accommodating unit according to the present invention in a constitution in this embodiment will be described. Incidentally, constituent elements similar to those in the above-described embodiments are partly represented by the same reference numerals or symbols and are partly represented by different reference numerals or symbols, and will be omitted from redundant description.

FIG. 17 is a schematic view of a retaining portion 418e of a developer accommodating unit 25 in this embodiment as seen by projecting the retaining portion 418e on a plane perpendicular to an axis 418d of a fixing shaft portion 418a, and is illustration showing a scare in which an outer end portion 418i of a locking edge line 418f outside an edge portion of a fastening hole 416d has a distance closer to the first bonding portion 22a than a locking portion 418h where the edge portion of the fastening hole 416d is locked.

In Seventh Embodiment described above, as shown in FIG. 15, the retaining portion 318e is projected on the plane perpendicular to the axis 318d of the fixing shaft portion 318a.

At that time, the locking edge line 318f of the retaining portion 318e for locking the edge portion of the fastening hole 316d when the sealing member 19 is unsealed are considered. On the looking edge line 318f, the outer end portion 318i, outside the edge portion of the fastening hole 316d on the locking edge line 318l, was disposed, remoter from the first bonding portion 22a than the locking portion 318h where the edge portion of the fastening hole 316d was locked.

In this embodiment, as shown in FIG. 17, the retaining portion 418e is projected on the plane perpendicular to the axis 418d of the fixing shaft portion 418a.

At that time, the locking edge line 418f of she retaining portion 418e for locking the edge portion of the fastening hole 416d when the sealing member 19 is unsealed are considered. On the locking edge line 418f, the outer end portion 418i is disposed downstream (in an upper side in FIG. 17) of the locking portion 418h, where the edge portion of the fastening hole 416d is locked, with respect to the unsealing direction of the sealing portion 19a, and is disposed closer to the first bonding portion 22a than the locking portion 418h. The outer end portion 418i is the outermost portion disposed outside the edge portion of the fastening hole 416d on the locking edge line 418f.

As a result, the developing bag 16 is pulled via the sealing member 19. Then, the edge portion of the fastening hole 416d receives a moving force M1 directed, along the locking edge line 418f, from the locking portion 418i, outside the edge portion of the fastening hole 416d on the locking edge line 418f, toward the locking portion 418h where the edge portion of the fastening hole 416d is locked. By the moving force M1, the edge portion of the fastening hole 418d is shifted toward, the locking portion 418h. For this reason, even in a direction perpendicular to the axis 418d of the fixing shaft, portion 418a, a force for engaging the edge portion of the fastening hole 416d from the retaining portion 418e is not generated. As a result, it is possible to stably realise the unsealing of the openings 35a of the developing bag 16.

Also in this embodiment, similarly as in Seventh Embodiment described above, the locking edge line 148f of the retaining portion line for preventing the edge portion of the elliptical fastening hole 416d from, being disengaged from the fixing shaft portion 418a by locking the edge portion of the fastening hole 416d provided in the developing bag 16 when the sealing member 19 is unsealed is considered. A constitution in which on the locking edge line 148f, the outer end portion 148i is projected toward the fastening hole 416d, with respect to the direction of the axis 418d of the fixing shaft portion 418a, more than the locking portion 418h where the edge portion of the fastening hole 416d is locked. The outer end portion 418i is the outermost portion disposed outside the edge portion of the fastening hole 416d on the locking edge line 418f.

In this embodiment, the retaining portion 418e is projected on the plane perpendicular to the axis 418d of the fixing shaft portion 418a. A distance from the outer end portion 418i to the first bonding portion 22a which is a downstream end portion of the unsealing direction is smaller than a distance from the Locking portion 418h, where true edge portion of the fastening hole 416d is contacted, to the first bonding portion 22a. The outer end portion 418i is the outermost portion outside the edge portion of the fastening hole 416d on the locking edge line 418f.

In another constitution, as described, later with reference to FIG. 19, the outer end portion 418i and the looking portion 418a where the edge portion of the fastening hole 416d may also be disposed on the same line perpendicular to the pulling direction (arrow L direction of FIG. 17) of the edge portion of the fastening hole 416d. In this case, the outer end portion 418i is the outermost portion disposed outside the edge portion of the fastening hole 416d on the locking edge line 418f.

Further, the locking edge line 418f has a shape of a rectilinear line connecting the locking portion 418h, where the edge portion of the fastening hole 416d, with the outer end portion 418i outside the edge portion of the fastening hole 416d on the locking edge line 418f. As another constitution, similarly as in Second Embodiment described above with reference to (a) of FIG. 11, the locking edge line 418f may also have a curved shape. Other constitutions are the same as those in the above-described embodiments, and a similar effect can be obtained.

### Ninth Embodiment

Next, with reference to FIGS. 18 to 20, a developer accommodating unit according to the present invention in a constitution in this embodiment will be described. Incidentally, constituent elements similar to those in the above-described, embodiments are partly represented by the same reference numerals or symbols and are partly represented by different reference numerals or symbols, and will be omitted from redundant description.

FIG. 18 is a perspective illustration showing a state in which in a developer accommodating unit 25 in this embodiment, an outer end portion 518i outside an edge portion of a fastening hole 516d is projected toward the fastening hole, with respect to a direction of an axis 518d of a fixing shaft portion 518a, more than a looking portion 518h where the edge portion of the fastening hole 516d is locked. The outer end portion 518i is the outermost portion disposed outside the edge portion of the fastening hole 516d on the locking edge line 518f.

FIG. 19 is a schematic view of a retaining portion 518e in this embodiment as seen by projecting the retaining portion 518e on a plane perpendicular to an axis 518d of a fixing shaft portion 518a, at that time, an outer end portion 518i of a locking edge line 518f outside an edge portion of a fastening hole 516d and a locking portion 518h where the edge portion of the fastening hole 516d is locked have the same distance to the first bonding portion 22a.

Further, the outer peripheral surface of the fixing shaft portion 518a and she locking edge line 518f of the retaining portion 518e contact each other.

FIG. 20 is a sectional illustration showing a state in which an outer end portion 518i of a retaining portion 518e is projected toward the fastening hole 516d, with respect to a direction of an axis 518d of a fixing shaft portion 518a, more than a locking portion 518h where the edge portion of the fastening hole 516d is locked in this embodiment. The outer end portion 518i is the outermost portion disposed outside the edge portion of tree fastening hole 516d on the locking edge line 518f.

As shown in FIGS. 18 to 20, in this embodiment; the locking edge line 518f of the retaining portion 518e for preventing the edge portion of the fastening hole 516d from being disengaged from trio fixing shaft portion 518a, which is provided to stand at tire inner surface of the second frame 18 and which is fixed by being inserted into the fastening hole 516d provided in the developing bag 16 is considered. The locking edge line 518f is projected on a plane perpendicular to the axis 518d of the fixing shaft portion 518a.

At that time, on the locking edge line 518f of the retaining portion 518e for locking the edge portion of the fastening hole 516d when the sealing member 19 is unsealed, the outer end portion 518i and the locking portion 518h are disposed in positions such that these portions are aligned with each other in a direction, perpendicular to the pulling direction (arrow L direction of FIG. 19) of the edge portion of the fastening hole 516d. Further, a constitution in which a distance from the outer end portion 518i to the first bonding portion 22a is equal to a distance from the locking portion 518h to the first, bonding portion 22a is employed. The outer end portion 518i is the outermost portion disposed, outside the edge portion of the fastening hole 516d on the locking edge line 518f. The locking portion 518h is the portion where the edge portion of the fastening hole 516d is locked.

Further, as shown in FIG. 19, the outer peripheral surface of the fixing shaft portion 518a and the locking edge line 518f of the retaining portion 518e contact, each other. That is, on a rectilinear line connecting the two locking portions 518h on the locking edge line 518f of the retaining portion 518e where the cage portion of the fastening hole 516d is locked, there is a contact point 518h with the outer peripheral surface of the fixing shaft portion 518a.

A constitution in which at a portion, where the edge portion of the fastening hole 516d is movable, in an upstream side (rear side) of the locking edge line 518f of the retaining portion 518e with respect to the arrow L direction of FIG. 19, the fixing shaft portion 518a is provided with a projected portion 518p having a distance, from the first bonding portion 22a, larger (remoter) than the retaining portion 518e is employed. That is, the outer peripheral surface of the fixing shaft portion 518a is projected, relative to the retaining portion 518e, toward the upstream side with respect to the arrow L direction. As a result, a length of the retaining portion 518e with respect to the arrow L direction of FIG. 19 is smaller than an outer diameter of the fixing shaft portion 518a.

First, an effect that the distance to the first bonding portion 22a from the locking portion 518h where the edge portion of the fastening hole 516d is locked and the distance to the first bonding portion 22a from the outer end portion 518i outside the edge portion of the fastening hole 516d on the locking edge line 518f are equal to each other as shown in FIG. 19 will be described.

The edge portion of the fastening hole 516d is expanded so as to ride over the retaining portion 518e by its elastic deformation, so that the fixing shaft portion 518a is inserted into the fastening hole 516d. In this case; the constitution is compared with a constitution in the case where the distance to the first bonding portion 22a is smaller at the outer end portion 518i, outside the edge portion of the fastening hole 516d on the locking edge line 518f, than at the locking portion 516h where the edge portion of the fastening hole 515d is locked. Then, an amount of the elastic deformation of the edge portion of the fastening hole 516d can be suppressed at a low level, so that it is possible to easily perform an assembling operation of the fastening hole 516d with the fining shaft portion 518a.

Next, an effect in the case where the contact point 518n where the outer peripheral surface of the fixing shaft portion 518a and the locking edge line 518f of the retaining portion 518e contact each other and the projected portion 518p having the larger distance, from the first bonding portion 22a, than the retaining portion 518e will be described.

The fixing shaft portion 518a has the contact point 518n and the projected portion 518p. As a result, when the fastening hole 516d is assembled with the fixing shaft portion 518a, with respect to the arrow L direction of FIG. 19, it is possible to form a shape such that, a minimum spacing is formed between the fastening hole 516d and the fixing shaft portion 518a without being influenced by the shape of the retaining portion 518e.

As a result, it is possible to minimize an amount of movement of the developing bag 16 in the arrow L direction of FIG. 19 during the unsealing of the sealing member 19. As a result, it is possible to realize satisfactory unsealing of the openings 35a of the developing bag 16.

Further, the fastening hole 516d is assembled with the fixing shaft portion 518a. At that time, a portion of the retaining portion 516e excluding the locking edge line 518l is made small in shape. As a result, during the assembling of the fastening hole 516d with the fixing shaft portion 518a, the elastic deformation amount of the edge portion of she fastening hole 516d can be suppressed at a low level. As a result, it is possible to easily perform the assembling operation of the fastening hole 516d with the fixing shaft portion 518a.

In this way, when the retaining portion 518e, the fixing shaft portion 518a and the fastening hole 516d in this embodiment are used, it is possible to minimise an amount of relative change in positional relationship between the developer supplying roller 23 and the openings 35a. Further, the assembling operation of the fastening hole 516d with the fixing share portion 518a can be easily performed.

As shown in FIG. 19, the locking edge line 518f is projected on the plane perpendicular to she axis 518d of the fixing shaft portion 518a. At that time, on the locking edge line 518f, the locking portion 518h where the edge portion of the fastening hole 516d is locked and the outer end portion 518h outside the edge portion of the fastening hole 516d are disposed on the same rectilinear line. With respect to a direction of the axis 518d of the fixing shaft portion 518a shown in FIG. 20, a force for moving the edge portion of the fastening hole 516d from the locking portion 518h, where the edge portion of the fastening hole 516d is locked, toward the outer end portion 518i outside the edge portion of the fastening hole 516d on the locking edge line 518f is not generated. As a result, it is possible to stably realize the unsealing of the openings 35a of the developing bag 16.

In this embodiment, an example in which the fixing shaft portion 518a is provided with the contact point 518n and the projected portion 518p is described, but even in the case where only the contact point 518n is provided, such an effect that the assembling operation can be easily performed can be obtained.

Incidentally, as shown in FIGS. 18 and 20, the outer end portion 518i of rite retaining portion 518e is projected, toward the fastening hole 516d (the lower side of FIGS. 18 and 20) with respect to the direction of the axis 516d of the fixing shaft portion 518a, more than the locking portion 518h where the edge portion of the fastening hole 516d is locked. The outer end portion 518i is the outermost portion disposed outside the edge portion of the fastening hole 516d on the locking edge line 518f. Other constitutions are the same as those in the above-described embodiments, and a similar effect can be obtained.

### Tenth Embodiment

Next, with reference to FIG. 21, a developer accommodating unit according to the present invention in a constitution in this embodiment will be described. Incidentally, constituent elements similar to those in the above-described, embodiments are represented by the same reference numerals or symbols and will be omitted from description.

FIG. 21 is a schematic view of a retaining portion 518e of the developer accommodating unit 25 in this embodiment as seen by projecting the retaining portion 518e on a plane perpendicular to an axis 518d of a fixing shaft portion 518a. At that time, an outer end portion 518i of a locking edge line 518f outside an edge portion of a fastening hole 516d and a locking portion 518h where the edge portion of the fastening hole 516d is locked have the same distance to the first bonding portion 22a. Further, FIG. 21 is an illustration showing a state in which the outer peripheral surface of the fixing shaft portion 518a is projected from the locking edge line 518f of the retaining portion 518e toward front and rear sides (upstream and downstream sides) of the arrow L direction of FIG. 21 which is the direction where the fastening hole 516d is movable.

In Ninth Embodiment described above, as described above with reference to FIG. 19, the constitution in which the contact point 518n with the fixing shaft portion 518a is disposed, on the rectilinear line connecting the pair of locking portions 518h where the edge portion of the fastening hole 516d is locked on the locking edge line 518f was employed.

In this embodiment, as shown in FIG. 21, the outer peripheral surface of the fixing shaft portion 518a is projected from the rectilinear line connecting the pair of locking portions 518h toward the front and rear sides (upstream and downstream sides) of the arrow L direction in FIG. 21. Further, a constitution in which a pair of intersection points 518g where the rectilinear line connecting the pair of locking portions 518h intersects with the outer peripheral surface of the fixing shaft portion 518a is provided is employed. The pair of locking portions 518h is a portion where the edge portion of the fastening hole 516d is locked on the locking edge line 518f of the retaining portion 518e. The arrow L direction of FIG. 21 is a direction in which the edge portion of the fastening hole 516 is moved by rotating the unsealing member 20 about the rotation shaft 20d to pull the developing bag 16 via the sealing member 19.

Incidentally, this embodiment is constituted similarly as Ninth Embodiment described above with reference to FIGS. 18 and 20. That it, an outer end portion 518i of a retaining portion 518e is projected toward the fastening hole 516d with respect to a direction of an axis 518d of a fixing shaft portion 518a, more than a locking portion 518h where the edge portion of the fastening hole 516d is locked. Other constitutions are the same as those in the above-described embodiments, and a similar effect can be obtained.

### Eleventh Embodiment

Next, with reference to FIG. 22, a developer accommodating unit, according to the present invention in a constitution in this embodiment will be described. Incidentally, constituent elements similar to those in the above-described embodiments are represented by the same reference numerals or symbols and will be omitted from description.

In the above-described embodiments, the example of the developing bag 10 as the flexible container accommodating the developer and provided with the openings 35a for permitting discharge of the developer was described. In this embodiment, as the flexible container accommodating the developer and provided with tire openings 35a for permitting discharge of the developer, a developer accommodating member 34 is used.

As shown in FIG. 22, the developer accommodating container 30 including the unsealing member 20 is constituted, similarly as in the above-described embodiments, by the developer accommodating member 34, the sealing member 19, the unsealing member 20, the first frame 17, the second frame 18 and the like.

### <Developer Accommodating Member>

In FIG. 22, the developer accommodated member 34 includes a container body portion 34a which is a flexible container manufactured by subjecting a sheet-like material to vacuum molding, air-pressure molding, press molding, insertion molding or the like. Further, the developer accommodating member 34 includes a sheet portion 34b, having flexibility, for covering the container body portion 34a in an opening side. Bonding between the container body portion 34a and the sheet portion 34b is made by using (thermal) welding, laser welding, an adhesive, an adhesive tape, or the like.

As a material for the container body portion 34a, it is possible to use an acrylonitrile butadiene styrene copolymer (ABS) and polymethylmethacrylate (PMMA). Further, it is also possible to use polycarbonate (PC), polypropylene (FP), polyethylene (PE), high-impact polystyrene (HIPS), polyethylene terephthalate (PET), polyvinyl chloride (PVC), and composite multi-layer materials of these polymers.

Incidentally, the high-impact polystyrene (HIPS) is prepared by adding a rubber-like polymer or a rubber-like copolymer to polystyrene (PS). The rubber-like polymer or copolymer is selected from the group consisting of polybutadiene, styrene-butadiene copolymer, polyisoprene, butadiene-isoprene copolymer, natural rubber, and ethylene-propylene copolymer.

A thickness of the container body portion 34a may preferably be 0.1 mm to 1 mm as a thickness of the sheet-like member before the molding since the resultant portion is excellent in flexibility. The material and the thickness of the container body portion 34a can be appropriately be set depending on cost, product specifications, manufacturing condition, and the like.

Incidentally, even when the developer accommodating member 34 in this embodiment is used in place of the developing bag 16 used in the above-described embodiments, effects similar to those in the above-described embodiments can be obtained. Other constitutions are the same as those in the above-described embodiments, and a similar effect can be obtained.

According to the present invention, in the developer accommodating unit using the flexible container for accommodating the developer, it is possible to fix the flexible container on the frame by a simple method, so that it is possible to reliably unseal the sealing portion, for sealing the openings of the flexible container, by the movement of the sealing member.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 198090/2012 filed Sep. 10, 2012, which is hereby incorporated by reference.

What is claimed is:

1. A developer accommodating unit for accommodating a developer, comprising:
a flexible container, provided with an opening for permitting discharge of the developer, for accommodating the developer; and
a frame,
wherein said flexible container is provided with a fastening hole for fastening said flexible container in said frame,
wherein said frame includes a fixing shaft portion fixed in the fastening hole by being inserted into the fastening hole and includes a retaining portion for preventing the fixing shaft portion from being disengaged from the fastening hole, and
wherein the fastening hole is locked by fitting the fastening hole around the fixing shaft portion while an edge of the fastening hole rides over the retaining portion by elastic deformation thereof.

2. A developer accommodating unit according to claim 1, further comprising a sealing member, which includes a sealing portion for sealing the opening and which is mounted on said flexible container, capable of exposing the opening by being moved.

3. A developer accommodating unit according to claim 1, wherein when the retaining portion is projected on a plane perpendicular to an axis of the fixing shaft portion, on a locking edge line of the retaining portion for locking the edge portion of the fastening hole when a sealing member is unsealed, an outer end portion of the locking edge line outside the edge portion of the fastening hole is provided downstream, with respect to a predetermined direction, of a looking portion where the edge portion of the fastening hole is locked or is provided at a position where the outer end portion is aligned with the locking portion in a direction perpendicular to the predetermined direction.

4. A developer accommodating unit according to claim 1, wherein on a locking edge line of the retaining portion for locking the edge portion of the fastening hole when a sealing member is unsealed, an outer end portion of the locking edge line outside the edge portion of the fastening hole is projected toward the fastening hole, with respect to an axial direction of the fixing shaft portion, more than a locking portion where the edge portion of the fastening hole is locked.

5. A developer accommodating unit according to claim 2, further comprising an unsealing member for moving said sealing member.

6. A developer accommodating unit according to claim 5, wherein said frame accommodates said unsealing member.

7. A developer accommodating unit for accommodating a developer, comprising;
a flexible container, provided wish an opening for permitting discharge of the developer, for accommodating the developer;
a sealing member which includes a sealing portion for sealing she opening and which is mounted on said flexible container, capable of exposing the opening by being moved;
an unsealing member for moving said sealing member; and
a frame for accommodating said unsealing member,
wherein said flexible container is provided with a fastening hole for fastening said flexible container in said frame,
wherein said frame includes a fixing shaft portion fixed in the fastening hole by being inserted into the fastening hole and includes a retaining portion for preventing the fixing shaft portion from being disengaged from the fastening hole,
wherein the fastening hole is locked by fitting the fastening hole around the fixing shaft portion while an edge of the fastening hole rides over the retaining portion by elastic deformation thereof, and is pulled in a predetermined direction when said sealing member is unsealed, and
wherein when the retaining portion is projected on a plane perpendicular to an axis of the fixing shaft portion, on a locking edge line of the retaining portion for locking the edge portion of the fastening hole when said sealing member is unsealed, an outer end portion of the locking edge line outside the edge portion of the fastening hole is provided downstream, with respect to the predetermined direction, of a locking portion where the edge portion of the fastening hole is locked or is provided at a position where the outer end portion is aligned with the locking portion in a direction perpendicular to the predetermined direction.

8. A developer accommodating unit for accommodating a developer, comprising:
a flexible container, provided with an opening for permitting discharge of the developer, for accommodating the developer;
a sealing member which includes a sealing portion for sealing the opening and which is mounted on said flexible container, capable of exposing the opening by being moved;
an unsealing member for moving said sealing member; and
a frame for accommodating said unsealing member,
wherein said flexible container is provided with a fastening hole for fixing said flexible container in said frame,
wherein said frame includes a fixing shaft portion fixed in the fastening hole by being inserted into the fastening hole and includes a retaining portion for preventing the fixing shaft portion from being disengaged from the fastening hole,
wherein the fastening hole is locked by fitting the fastening hole around the fixing shaft portion while an edge of the fastening hole rides over the retaining portion by elastic deformation thereof, and
wherein on a locking edge line of the retaining portion for locking the edge portion of the fastening hole when a sealing member is unsealed, an outer end portion of the locking edge line outside the edge portion of the fastening hole is projected toward the fastening hole, with respect to an axial direction of the fixing shaft portion, more than a locking portion where the edge portion of the fastening hole is locked.

9. A developer accommodating unit according to claim 7, wherein an outer end portion of the locking edge line outside the edge portion of the fastening hole is projected toward the fastening hole, with respect to an axial direction of the fixing shaft portion, more than a locking portion where the edge portion of the fastening hole is locked.

10. A developer accommodating unit according to claim 7, wherein when the retaining portion is projected on a plane perpendicular to an axis of the fixing shaft portion, on a locking edge line of the retaining portion for locking the edge portion of the fastening hole when a sealing member is unsealed, the retaining portion is provided at a position where an outer end portion of the locking edge line outside the edge portion of the fastening hole and a locking portion where the edge portion of the fastening hole is locked is aligned with each other in a direction perpendicular to the predetermined direction of said sealing member.

11. A developer accommodating unit according to claim 7, wherein an outer peripheral surface of the fixing shaft portion is projected toward an upstream side of the retaining portion with respect to the predetermined direction.

12. A process cartridge comprising;
a developer accommodating unit according to claim 1, and
an image bearing member for bearing a toner image.

13. An image forming apparatus for forming an image on a sheet by using a developer, comprising:
a process cartridge according to claim 12,
wherein the process cartridge is detachably mountable to said image forming apparatus.
